(19) United States
(12) Patent Application Publication
(10) Pub. No.: US 2026/0024108 A1
(43) Pub. Date: Jan. 22, 2026

(54) INTEGRATED AD-BLOCKER AND DYNAMIC REWARDS SELECTOR SYSTEM

(71) Applicant: The People’s Internet Experiment, Inc., Marina Del Rey, CA (US)

(72) Inventors: Anthony Le, Los Angeles, CA (US); Eric Posen, Los Angeles, CA (US); Brian Luscombe, New York, NY (US); Ryan Hudson, Tujunga, CA (US); Kin Ing Thai, Monterey Park, CA (US); Spencer Allen Charest, Los Angeles, CA (US); Wallace Lu Lee, Monterey Park, CA (US)

(21) Appl. No.: 19/274,031

(22) Filed: Jul. 18, 2025

Related U.S. Application Data
(60) Provisional application No. 63/673,141, filed on Jul. 18, 2024.
(60) Provisional application No. 63/733,969, filed on Dec. 13, 2024.

(51) Int. Cl. G06Q 30/0226; G06Q 30/0241

(52) U.S. Cl. CPC G06Q 30/0231; G06Q 30/0277

(57) ABSTRACT

In some implementations, a device may be configured to detect an advertisement on a webpage. In addition, the device may be configured to replace the detected advertisement with a visually distinct placeholder within the webpage's content. The device may be configured to animate the placeholder to indicate the removal of the advertisement. Moreover, the device may be configured to remove the placeholder to render the webpage as ad-free to the user. Also, the device may be configured to detect an affiliate tag associated with a rewards program on the webpage. Further, the device may be configured to present a prompt to the user with options to: block the affiliate tag, retain the existing tag, or use an integrated rewards program. In addition, the device may be configured to receive the user's selection from the prompt. The device may include executing the user's selection to manage the tag accordingly.

### CROSS-REFERENCE TO RELATED APPLICATION

This application claims priority to U.S. Provisional Patent Application No. 63/733,969, filed on Dec. 13, 2024, and U.S. Provisional Patent Application No. 63/673,141, filed on Jul. 18, 2024, both of which are hereby expressly incorporated by reference in their entireties for all purposes.

### TECHNICAL FIELD

The present disclosure relates generally to Internet browsing technologies and, more specifically, to systems and methods for enhancing user experiences with ad-blocking and/or rewards programs.

### BACKGROUND

The widespread use of online advertising has led to an increased adoption of ad-blockers by Internet users seeking a better browsing experience. Ad-blockers prevent advertisements from being displayed on webpages, which helps to reduce distractions, improve page load times, and protect user privacy by blocking tracking mechanisms. Despite their benefits, traditional ad-blockers often do not provide precise feedback to users about their effectiveness, leading to uncertainty about the value the ad-blockers deliver.

Simultaneously, affiliate-based rewards programs have become popular by offering users monetary incentives, discounts, or other benefits in exchange for purchasing through designated affiliate links. However, these programs face challenges when users employ ad-blockers, as blocking trackers can interfere with the affiliate tagging process. This conflict creates a need for a solution that allows users to enjoy the benefits of both ad-blockers and rewards programs without compromising their core functionalities.

Current ad-blockers typically focus on providing statistical data about blocked ads and network requests, which can be confusing for average users. Additionally, ad-blockers and rewards programs usually operate independently, with no integration that allows users to manage both functionalities dynamically.

There is a need for an integrated system that enhances the user's browsing experience by providing clear feedback on ad-blocking activities and offering a dynamic way to manage rewards program participation. Such a system would improve transparency and user engagement, addressing the limitations of existing solutions.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include detecting an advertisement on a webpage. The method may also include replacing the detected advertisement with a visually distinct placeholder within the webpage's content. The method may include animating the placeholder to indicate the removal of the advertisement. Additionally, the method may include removing the placeholder to render the webpage as ad-free to the user. The method may also include detecting an affiliate tag associated with a rewards program on the webpage. Additionally, the method may also include presenting a prompt to the user with options to block the affiliate tag, retain the existing affiliate tag, or use an integrated rewards program. The method may also include receiving the user's selection from the prompt. Additionally, the method may include executing the user's selection to manage the affiliate tag accordingly.

In one general aspect, a device may include one or more processors configured to: detect an advertisement on a webpage. The one or more processors may also be configured to replace the detected advertisement with a visually distinct placeholder within the webpage's content. Additionally, the one or more processors may be configured to animate the placeholder to indicate the removal of the advertisement. The one or more processors may also be configured to remove the placeholder to render the webpage as ad-free to the user. Additionally, the one or more processors may be configured to detect an affiliate tag associated with a rewards program on the webpage. The one or more processors may also be configured to present a prompt to the user with options to: block the affiliate tag, retain the existing affiliate tag, or use an integrated rewards program. The one or more processors may also be configured to receive the user's selection from the prompt. Additionally, the one or more processors may be configured to execute the user's selection to manage the affiliate tag accordingly.

In one general aspect, a non-transitory computer-readable medium may include one or more instructions that, when executed by one or more processors of a device, cause the device to detect an advertisement on a webpage. The one or more instructions may, when executed by the one or more processors of the device, cause the device to replace the detected advertisement with a visually distinct placeholder within the webpage's content. Additionally, the one or more instructions may, when executed by the one or more processors of the device, cause the device to animate the placeholder to indicate the removal of the advertisement. The one or more instructions may, when executed by the one or more processors of the device, cause the device to remove the placeholder to render the webpage as ad-free to the user. Additionally, the one or more instructions may, when executed by the one or more processors of the device, cause the device to detect an affiliate tag associated with a rewards program on the webpage. The one or more instructions may, when executed by the one or more processors of the device, cause the device to present a prompt to the user with options to: block the affiliate tag, retain the existing affiliate tag, or use an integrated rewards program. Additionally, the one or more instructions may, when executed by the one or more processors of the device, cause the device to receive the user's selection from the prompt. The one or more instructions may, when executed by the one or more processors of the device, cause the device to execute the user's selection to manage the affiliate tag accordingly.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIGS. 1A-1C provide a flowchart of an example process in accordance with the systems and methods described herein.

FIG. 2 is a block diagram of an example device configured to perform the process illustrated in FIG. 1 in accordance with the systems and methods described herein.

FIG. 3 is a diagram illustrating an example webpage view in accordance with the systems and methods described herein.

FIG. 4 is a diagram illustrating an example view of a reward selector window in accordance with the systems and methods described herein.

FIG. 5 is a diagram illustrating an example view of an affiliate reward blocker window in accordance with the systems and methods described herein.

FIG. 6 is a flowchart of an example process in accordance with the systems and methods described herein.

FIG. 7 is a flowchart of an example process in accordance with the systems and methods described herein.

FIG. 8 is a flowchart of an example process in accordance with the systems and methods described herein.

FIGS. 9A-9E forms a diagram illustrating a high-level flowchart of the data experience within the integrated ad-blocker and dynamic rewards selector system in accordance with the systems and methods described herein.

FIG. 10 illustrates an example user interface screen showing an invitation for a user to participate in Money Mode by referring additional users, in accordance with the systems and methods described herein.

FIG. 11 illustrates an example Rewards Hub interface where the user can view detailed information about the opportunity to earn points in Money Mode, in accordance with the systems and methods described herein.

FIG. 12 illustrates an example asset displaying the user's current status in Money Mode, including progress towards earning rewards, in accordance with the systems and methods described herein.

FIG. 13 illustrates another example asset informing the user of their progress in clearing contingent rewards while in Money Mode, in accordance with the systems and methods described herein.

FIG. 14 illustrates an example user interface screen showing Money Mode operating to remove advertisements, in accordance with the systems and methods described herein.

FIG. 15 illustrates an example user interface screen reinforcing the user's engagement with Money Mode by displaying a message about the number of points earned for the action, in accordance with the systems and methods described herein.

FIG. 16 is a flowchart of an example process, in accordance with the systems and methods described herein.

FIGS. 17A-B is a flowchart of an example process, in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Embodiments of the systems, methods, and devices described herein may have one or more of the following capabilities. For example, one embodiment of the systems, methods, and devices described herein may include

In one example embodiment, the present disclosure may relate to an integrated system that enhances user experience by combining ad-blocking functionality with rewards program management within a web browser environment. The system may include a method for visually reinforcing ad-blocking actions and dynamically managing affiliate tags associated with rewards programs.

Ad-blocker Visual Mode

In some example embodiments, an example device may be configured to detect an advertisement on a webpage. Detecting an advertisement on a webpage involves accessing the HTML content of the webpage and parsing the HTML to identify elements that match known advertisement patterns. These patterns may include specific tags, URLs associated with ads, or other indicators that help identify advertisements within the webpage content.

Upon detection, the device may replace the detected advertisement with a visually distinct placeholder within the webpage's content. The placeholder may serve as a temporary visual marker that signifies the presence of an advertisement.

The device may animate the placeholder to indicate the removal of the advertisement. For instance, the animation may involve fading the placeholder into the background, which visually represents the ad being eliminated. This process may reassure the user that the ad-blocker is functioning effectively, providing immediate visual feedback without requiring user interaction.

Once the animation is complete, the device may remove the placeholder, rendering the webpage as ad-free to the user. This seamless transition may ensure that the user's browsing experience is not disrupted while providing clear evidence of the ad-blocking activity. Removing the placeholder to render the webpage as ad-free may involve completing the animation sequence and deleting the placeholder element from the webpage's Document Object Model (DOM).

### Dynamic Rewards Selector

The device is further configured to detect affiliate tags associated with rewards programs on the webpage. Affiliate tags are often used to track user interactions and credit rewards for purchases made through specific links. Traditional ad-blockers may inadvertently block these tags, preventing users from receiving rewards.

To address this issue, the device may present a prompt to the user when an affiliate tag is detected, or may alternatively, apply a previously recorded user preference if such a preference has already been specified. The prompt may offer the user several options, such as: blocking the affiliate tag, retaining the existing tag, or using an integrated rewards program provided by the system. When the user has not previously selected a preference, the prompt may allow the user to make an informed decision about how to manage rewards and privacy. When a user preference has been previously stored, whether selected during a prior visit to the same webpage, for a given domain, or globally, the system may automatically apply that preference without presenting a new prompt. Presenting a prompt may include generating a user interface element with the available options and displaying it as a pop-up, modal, or inline dialog on the webpage or within a system interface. In some embodiments, the system may include an option to adjust or reset previously saved preferences through a settings interface.

Upon receiving the user's selection from the prompt, whether in response to a prompt or retrieved from a previously stored preference, the device executes the user's choice to manage the affiliate tag accordingly. For example, when the user opts to block the tag, the device will prevent the tag from being processed. When the user chooses to retain the tag or use the integrated rewards program, the device will ensure the tag is preserved and processed appropriately. Receiving the user's selection may involve capturing the user's interaction with the user interface element and storing the user's selection in a temporary or persistent storage, or retrieving the selection from such storage if previously saved.

Additionally, the device can save the user's selection for future visits to the same webpage. This feature streamlines the user experience by reducing the need for repeated interactions with the rewards selector prompt, thus enhancing convenience and user satisfaction.

Some embodiments may incorporate both the Ad-blocker Visual Mode and the Dynamic Rewards Selector. Other embodiments may feature only the Ad-blocker Visual Mode, while still others may include only the Dynamic Rewards Selector. Additionally, various embodiments may encompass one or more other aspects disclosed in the present application.

### Mobile Integration

In an example embodiment, the system's functionalities are not limited to desktop environments but extend to mobile devices as well, or other electronic devices that may incorporate a web browsing or similar capability. For example, in some embodiments, the ad-blocking and rewards management features may be integrated within a single mobile application, which may function as a browser extension or as a standalone mobile browser. This integration may ensure that users can enjoy the same enhanced browsing experience on their mobile devices as they do on other devices used to access information using a browser.

In an example embodiment, the mobile application may be designed to detect advertisements and affiliate tags on webpages accessed through an application. Such an embodiment may perform the same steps of replacing advertisements with placeholders, animating the advertisement's removal, and managing affiliate tags based on user preferences. This consistency across platforms may ensure a uniform user experience, whether on desktop, mobile, or other devices.

### Compensated Ad Viewing

In some implementations, the system may offer users the option to view advertisements in exchange for compensation. Users can opt-in to see ads, which may be displayed by the device either directly through the ad-blocker tool or via partnerships with publishers. Users may be compensated for viewing these ads, providing an additional incentive to engage with advertisements.

In an example embodiment, the device may track user interactions with the advertisements to determine the appropriate compensation, which may be in the form of monetary rewards, discounts, or other benefits. This feature may add a new dimension to the ad-blocking experience, allowing users to balance privacy concerns with potential rewards.

### System Architecture

In an example embodiment, the system may include a backend infrastructure that includes web servers and database servers to support the ad-blocking and rewards management functionalities. The backend may process user selections, manage affiliate tags, and tracks ad interactions for compensation purposes. The front-end software, running on user devices, may handle the detection and replacement of ads, presentation of prompts, and execution of user choices.

### User Interfaces

In an example embodiment, the user interfaces may be designed to be intuitive and user-friendly. The ad-blocker visual mode may provide clear, visual feedback on the blocking process, while the rewards selector prompt may offer straightforward options for managing affiliate tags. In an example embodiment, the mobile application interfaces may mirror those of the desktop environment, which may ensure consistency and ease of use.

In an example embodiment, the present disclosure may provide an integrated solution that enhances the ad-blocking experience by offering visual reinforcement of ad removal and dynamic management of rewards programs. This system addresses the limitations of existing ad-blockers and rewards programs, providing users with greater control and a more engaging browsing experience.

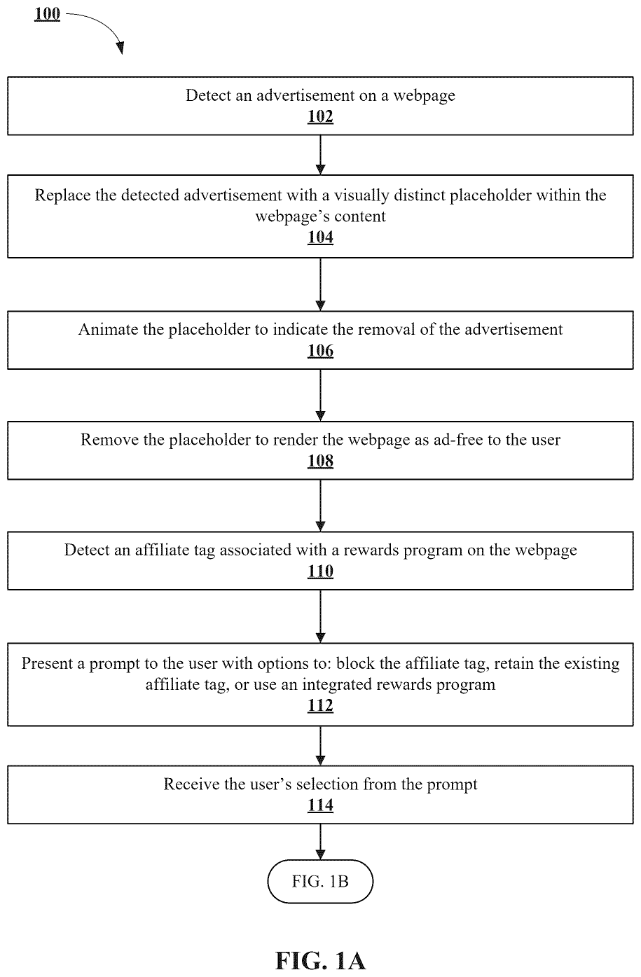

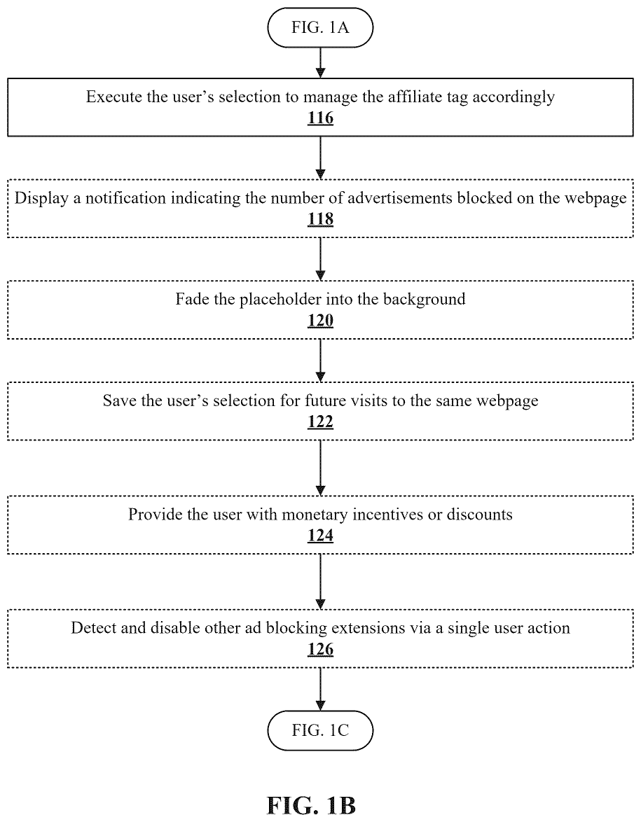

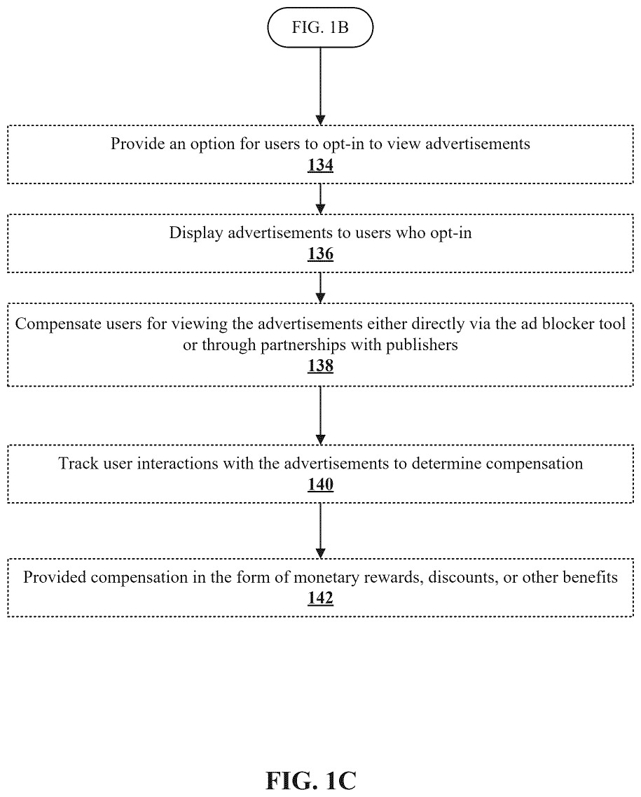

FIGS. 1A-1C provide a flowchart of an example process 100 in accordance with the systems and methods described herein. In some implementations, one or more process blocks of FIGS. 1A-1C may be performed by a device. As illustrated in FIG. 1A, process 100 may include detecting an advertisement on a webpage (block 102). For example, a device implementing method (process 100) may detect an advertisement on a webpage, as described above. In some example embodiments, detecting the webpage may include accessing the HTML content of the webpage and parsing the HTML to identify elements that match known advertisement patterns, such as specific tags or URLs associated with ads, for example.

As also illustrated in FIG. 1A, process 100 may include replacing the detected advertisement with a visually distinct placeholder within the webpage's content (block 104). For example, a device implementing the method may replace the detected advertisement with a visually distinct placeholder within the webpage's content, as described above. Replacing the detected advertisement with a visually distinct placeholder within the webpage's content may include creating a placeholder element with distinct visual properties (e.g., color, shape, pattern, opacity, animation effects, texture, shadow, gradient, icons or images, transparency, motion effects, or other distinct visual properties) and inserting the placeholder element into the webpage at the location of the detected advertisement.

As further illustrated in FIG. 1A, process 100 may include animating the placeholder to indicate the removal of the advertisement (block 106). For example, a device implementing the method may animate the placeholder to indicate the removal of the advertisement, as described above. In an example embodiment, animating the placeholder may include initiating an animation sequence for the placeholder element and adjusting the visual properties of the placeholder (e.g., opacity) to simulate fading.

As also illustrated in FIG. 1A, process 100 may include removing the placeholder to render the webpage as ad-free to the user (block 108). For example, a device implementing the method may remove the placeholder to render the webpage as ad-free to the user, as described above. Removing the placeholder to render the webpage as ad-free to the user may include completing the animation sequence and deleting the placeholder element from the webpage's Document Object Model (DOM).

As further illustrated in FIG. 1A, process 100 may include detecting an affiliate tag associated with a rewards program on the webpage (block 110). For example, a device implementing the method may detect an affiliate tag associated with a rewards program on the webpage, as described above. Detecting an affiliate tag may include scanning the webpage for known affiliate tag patterns and identifying the presence of affiliate tags based on URL parameters or script content.

As also illustrated in FIG. 1A, process 100 may include presenting a prompt to the user with options to block the affiliate tag, retain the existing affiliate tag, use an integrated rewards program, or some combination of these (block 112). For example, a device implementing the method may present a prompt to the user with options to block the affiliate tag, retain the existing affiliate tag, or use an integrated rewards program, as described above. Presenting a prompt may include generating a user interface element with the available options and displaying the user interface element as a pop-up or inline dialog on the webpage.

As further illustrated in FIG. 1A, process 100 may include receiving the user's selection from the prompt (block 114). For example, a device implementing the method may receive the user's selection from the prompt, as described above. Receiving the user's selection may include capturing the user's interaction with the user interface element and storing the user's selection in a temporary or persistent storage.

As also illustrated in FIG. 1B, process 100 may include executing the user's selection to manage the affiliate tag accordingly (block 116). For example, a device implementing the method may execute the user's selection to manage the affiliate tag, accordingly, as described above. Executing the user's selection may include modifying the webpage content based on the user's choice and updating the affiliate tag status, such as blocking, retaining, or replacing it with an integrated rewards tag.

As illustrated in FIG. 1B, process 100 may include additional implementations, such as any single implementation or any combination of implementations described below and/or in connection with one or more other processes described elsewhere herein. A first implementation, process 100 may include displaying a notification indicating the number of advertisements blocked on the webpage (block 118). In a second implementation, alone or in combination with the first implementation, the animation may include fading the placeholder into the background (block 120). A third implementation, alone or in combination with the first and second implementation, process 100 may include the step of saving the user's selection for future visits to the same webpage (block 122). In a fourth implementation, alone or in combination with one or more of the first through third implementations, the integrated rewards program may provide the user with monetary incentives or discounts (block 124). A fifth implementation, alone or in combination with one or more of the first through fourth implementations, process 100 may include detecting and disabling other ad-blocking extensions via a single user action (block 126).

In a sixth implementation, alone or in combination with one or more of the first through fifth implementations, the method may be performed on a mobile device within a single mobile application that integrates ad-blocking functionality and rewards program management. In a seventh implementation, alone or in combination with one or more of the first through sixth implementations, the mobile application may be a browser extension for a mobile browser. In an eighth implementation, alone or in combination with one or more of the first through seventh implementations, the mobile application may be a standalone mobile browser with built-in ad-blocking and rewards management functionality.

As illustrated in FIG. 1B, a ninth implementation, alone or in combination with one or more of the first through eighth implementations, process 100 further includes providing an option for users to opt-in to view advertisements (block 134); displaying advertisements to users who opt-in (block 136); compensating users for viewing the advertisements, e.g., either directly via the ad-blocker tool or through partnerships with publishers (block 138); and tracking user interactions with the advertisements to determine compensation (block 140). In a tenth implementation, alone or in combination with one or more of the first through ninth implementations, the compensation may be provided in the form of monetary rewards, discounts, or other benefits (block 142).

Although FIG. 1 illustrates example blocks of process 100, in some implementations, process 100 may include additional blocks, fewer blocks, different blocks, or differently arranged blocks than those depicted in FIG. 1. Additionally, or alternatively, two or more of the blocks of process 100 may be performed in parallel.

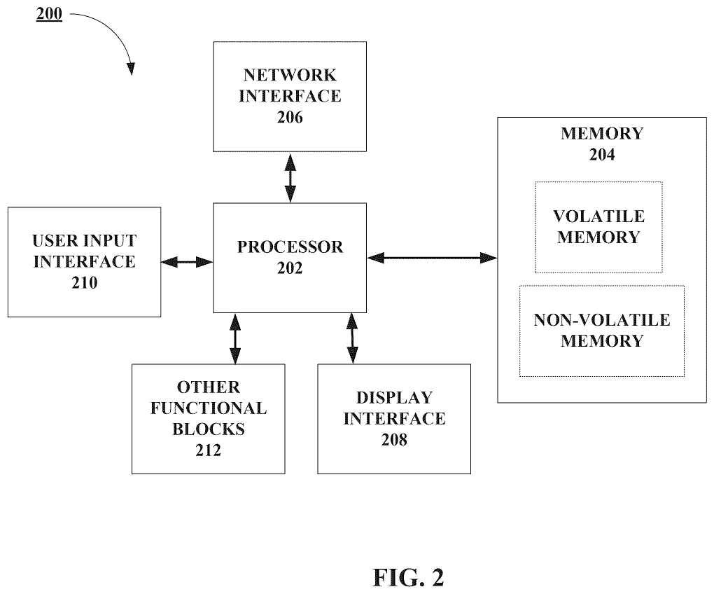

FIG. 2 is a block diagram of an example device 200 configured to perform the process 100 illustrated in FIG. 1 in accordance with the systems and methods described herein. Example device 200 includes several hardware components necessary for executing the steps of the process.

### Device Configuration

A processor 202, e.g., a central processing unit (CPU) or multiple CPUs, graphics processing units (GPUs), digital signal processors (DSPs), application-specific integrated circuits (ASICs), field-programmable gate arrays (FPGAs), system on chips (SoCs), microcontrollers, or any other processor circuitry may execute instructions to perform the steps of process 100 of FIG. 1. Processor 202 may manage and control the various tasks, such as detecting advertisements (block 102), replacing them with placeholders (block 104), animating these placeholders (block 106), and handling affiliate tags (block 110) of FIG. 1.

Memory 204, such as volatile memory, e.g., Random Access Memory (RAM) may temporarily store data and instructions during the execution of process 100. Non-volatile Memory (e.g., flash storage, SSD) may provide persistent storage for program code, user preferences, and other data.

A network interface 206 may include a network interface card (NIC) or wireless network adapter for communication with web servers and retrieving webpage content.

A display interface 208 may include a graphical processing unit (GPU) or integrated graphics controller for rendering visual elements, including placeholders and user prompts, on the device's display.

A user input interface 210 interfaces for receiving user input, such as a keyboard, mouse, or touchscreen, which may provide for interacting with the user prompts and capturing user selections.

Some example embodiments may implement one or more of the functions in one or more processors 202. Some example embodiments may implement all or substantially all of the functions in the one or more processors 202. Other example embodiments may implement a subset of the functions in the one or more processors 202.

Another example device may include functional blocks such as block(s) 212 for detecting an Advertisement on a Webpage. The processor 202, in conjunction with functional block(s) 212, may access and parses the HTML content of a webpage to identify elements that match known advertisement patterns. This may involve analyzing tags, URLs, and other indicators to detect ads. This functional block may perform the step of block 102 of FIG. 1.

A block 212 may provide for replacing the detected advertisement with a visually distinct placeholder. Upon detecting an advertisement, processor 202, in conjunction with functional block 212, may create a visually distinct placeholder element and insert the visually distinct placeholder into the webpage's content at the location of the detected advertisement. The placeholder is designed to be easily distinguishable by the user. This functional block may perform step of block 104 of FIG. 1.

Block 212 may provide for animating the placeholder to indicate the removal of the advertisement. Processor 202, in conjunction with functional block 212, may initiate an animation sequence for the placeholder element. This animation may include fading the placeholder into the background, visually indicates the removal of the advertisement, and/or enhancing user awareness. This functional block may perform step of block 106 of FIG. 1.

Block 212 may provide for removing the placeholder to render the webpage as ad-free. After the animation sequence is complete, the processor 202, in conjunction with functional block 212, may remove the placeholder element from the webpage's Document Object Model (DOM), rendering the webpage ad-free to the user. This functional block may perform step of block 108 of FIG. 1.

Block 212 may detect an affiliate tag associated with a rewards program. The processor 202, in conjunction with functional block 212, may scan the webpage for known affiliate tag patterns, identifying the presence of affiliate tags based on URL parameters or script content. This functional block may perform step of block 110 of FIG. 1.

Block 212 may present a prompt to the user with options for managing the affiliate tag. When an affiliate tag is detected, processor 202, in conjunction with functional block 212, may generate a user interface element presenting the user with options to block the affiliate tag, retain the existing affiliate tag, or use an integrated rewards program. This prompt may be displayed as a pop-up or inline dialog on the webpage. This functional block may perform step of block 112 of FIG. 1.

Block 212 may receive the user's selection from the prompt. The processor 202, in conjunction with functional block 212, captures the user's interaction with the prompt, storing the user's selection in a temporary or persistent storage. This functional block may perform step of block 114 of FIG. 1.

Block 212 may execute the user's selection to manage the affiliate tag accordingly. Based on the user's selection, processor 202, in conjunction with functional block 212, may modify the webpage content to manage the affiliate tag. This may involve blocking, retaining, or replacing the affiliate tag with an integrated rewards tag. This functional block may perform step of block 116 of FIG. 1.

### Additional Implementations

Process 100 may include additional implementations, such as displaying notifications, processor 202, in conjunction with any corresponding functional block(s) 212 (and display interface 208), may display a notification indicating the number of advertisements blocked on the webpage. Saving user preferences, processor 202, in conjunction with functional block(s) 212, (and memory 204) may save the user's selection for future visits to the same webpage, streamlining the user experience. mobile integration, the method may be performed on a mobile device within a single mobile application that integrates ad-blocking functionality and rewards program management. This may include both browser extensions for mobile browsers and standalone mobile browsers with built-in functionalities. In compensated ad viewing, processor 202, in conjunction with other functional block(s) 212, may provide options for users to opt-in to view advertisements, display these ads, compensate users for viewing them, and track interactions to determine compensation. Compensation may be provided as monetary rewards, discounts, or other benefits.

FIG. 2 may include additional components, fewer components, different components, or differently arranged components than those depicted. Additionally, or alternatively, two or more of the components of example device 200 may be combined.

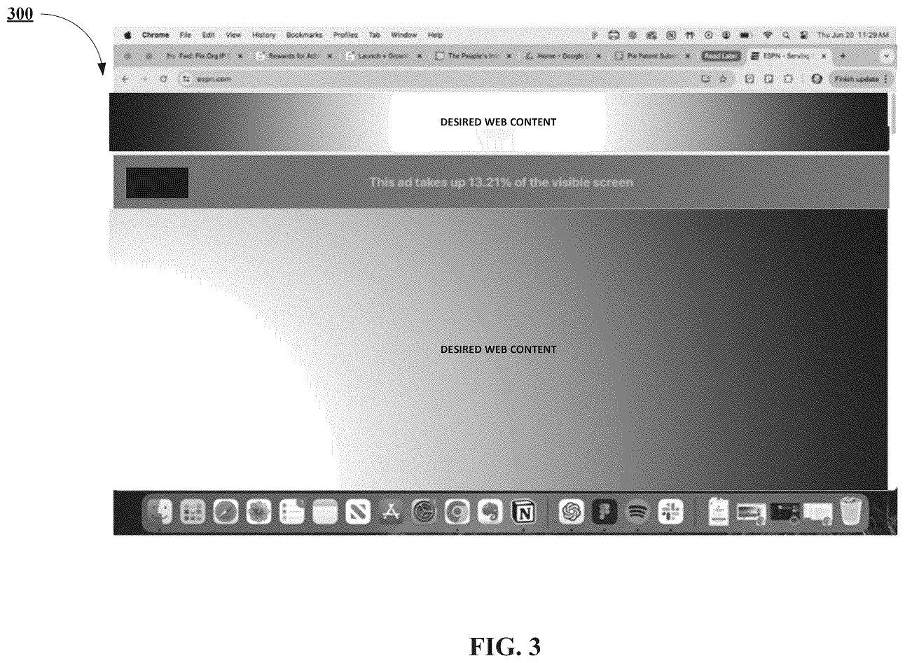

FIG. 3 is a diagram illustrating an example webpage 300 view in accordance with the systems and methods described herein. The webpage may display the original content with advertisements. The system may detect these advertisements and replaces them with visually distinct placeholders. These placeholders, illustrated in FIG. 3 as a gray box 302 with the text “This ad takes up 13.21% of the visible screen,” provide a clear visual indication that an advertisement has been blocked. Furthermore, useful information, e.g., the amount of screen space the ad takes up, e.g., 13.21%, is also provided. In an example embodiment, the calculation of the percentage may be based on the area of pixels that the ad would have taken (e.g., height times width) divided by your total screen pixels available to the webpage. Each ad may have that ad's own calculation. In an example embodiment, the percentages may be added together for multiple ads to provide a visual and/or numerical representation of the total percentage of visual space reclaimed. The placeholders may be animated to fade out, enhancing the user experience by illustrating the action of the ad-blocker in real-time. This visual feedback reassures users that the ad-blocker is actively working to remove advertisements from their browsing experience.

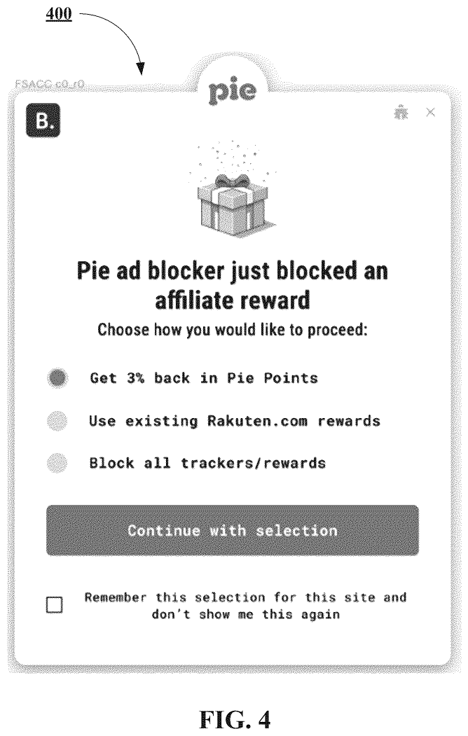

FIG. 4 is a diagram illustrating an example view of a reward selector window 400 in accordance with the systems and methods described herein. In FIG. 4, the system detects an affiliate tag associated with a rewards program on the webpage. Upon detection, a reward selector window 400 is displayed to the user. The reward selector window 400 presents several options for managing the affiliate tag, e.g., get 3% back in points, use existing rewards, blocking the tag, e.g., blocking all trackers/rewards, as well as a selection for remembering the selection in the future. Some embodiments may include other selections not illustrated here, such as retaining the existing tag or using another integrated rewards program provided by the system. Each option may be clearly labeled and accompanied by a brief description to help the user make an informed decision. The user may interact with the reward selector window 400 by selecting the user's preferred option, which the system will then execute to manage the affiliate tag accordingly.

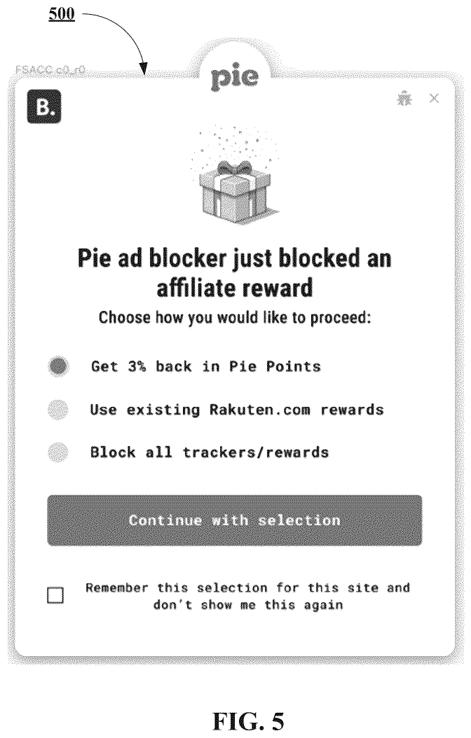

FIG. 5 is a diagram illustrating an example view of an affiliate reward blocker window 500 in accordance with the systems and methods described herein. Once an affiliate tag is detected, the system displays an affiliate reward blocker window 500 to the user. The reward blocker window 500 may offer the same or similar options to the reward selector window 400 illustrated in FIG. 4. For example, the reward blocker window 500 of FIG. 5 presents several options for managing the affiliate tag, e.g., get 3% back in points, use existing rewards, blocking the tag, e.g., blocking all trackers/rewards, as well as a selection for remembering the selection in the future.

In an example embodiment, the reward blocker window 500 may not only offer options to block or retain the affiliate tag but also provides detailed information about the integrated rewards program. Users may be informed about potential benefits, such as monetary incentives or discounts, that they can receive by opting into the rewards program. The affiliate reward blocker window 500 is designed to be user-friendly, with clear instructions and easy-to-use buttons, ensuring that users can manage their affiliate tags with minimal effort. In some example embodiments, the system may remember the user's selection for future visits to the same webpage, streamlining the experience and reducing repetitive interactions.

In some example embodiments, the integrated ad-blocker and dynamic rewards selector system may also enhance user security and privacy. By detecting and blocking potentially malicious advertisements and tracking mechanisms, the system can prevent harmful scripts from executing on the user's device. This functionality helps protect against security threats such as malware, phishing attacks, and unauthorized data collection, thereby providing a safer browsing experience.

Additionally, the system may improve overall device performance by reducing the load time of webpages. By blocking resource-intensive advertisements and trackers, the system decreases the amount of data that needs to be loaded and processed by the browser. This reduction in data load can lead to faster page rendering, lower bandwidth usage, and decreased power consumption, particularly beneficial for mobile devices with limited resources.

The integrated system may offer advanced user customization options, allowing users to tailor the ad-blocking and rewards functionalities to their preferences. Users can configure settings such as the level of ad-blocking, types of advertisements to be blocked, and specific rewards programs to be integrated. This high level of customization enhances user control and satisfaction by providing a personalized browsing experience.

The system is designed to be scalable and compatible with various web browsers and devices. Its modular architecture allows it to be easily adapted to different platforms, including desktop and mobile environments. The system can integrate seamlessly with popular web browsers through extensions or be embedded within custom browsers, ensuring broad applicability and ease of deployment.

The system utilizes efficient algorithms and data structures to detect and manage advertisements and affiliate tags. For instance, the system employs pattern matching techniques to identify ad elements in the HTML content of webpages quickly. It also uses optimized data storage mechanisms to track user preferences and interactions, ensuring minimal impact on system performance and resource usage.

In some embodiments, the system may leverage cloud services to enhance its capabilities. For example, it can use cloud-based databases to store and manage user preferences, ad-blocking rules, and rewards program data. This cloud integration allows for real-time updates and synchronization across multiple devices, providing a consistent user experience regardless of the device being used.

The system may include features for automatic updates and maintenance. These features ensure that the ad-blocking rules and rewards program integrations are always up to date, adapting to new types of advertisements and changes in rewards programs. Automatic updates help maintain the system's effectiveness and relevance over time without requiring manual intervention from users.

The system can provide detailed feedback and reporting to users about its activities. For example, it can generate reports showing the number of ads blocked, the types of ads blocked, and the rewards earned through integrated programs. This feedback enhances transparency and allows users to understand the system's impact on their browsing experience.

The system may employ advanced algorithms for detecting and blocking advertisements. For example, some embodiments use regular expressions with machine learning models to identify advertisement patterns within the HTML content of webpages. The data structures used for storing ad-blocking rules and user preferences may be optimized for quick retrieval and minimal memory usage, ensuring efficient operation even on resource-constrained devices.

The technical problem addressed by some embodiments may address the conflict between ad-blocking and affiliate-based rewards programs, which often operate independently and may interfere with each other. The integrated system may provide a technical solution by dynamically managing both functionalities within a unified framework, allowing users to enjoy ad-free browsing while still participating in rewards programs. This integration may be achieved through methods of detecting, blocking, and replacing advertisements and affiliate tags.

In one example use case, a user browsing an e-commerce website may encounter several advertisements and affiliate links. The system may detect these ads and replace them with visually distinct placeholders, enhancing the browsing experience by reducing clutter and distractions. Simultaneously, an example embodiment may detect affiliate tags and presents the user with options to manage them, ensuring that the user can still earn rewards from purchases made through affiliate links without compromising on ad-blocking.

Compared to other systems, some embodiments may offer several technical advantages. Traditional ad-blockers may inadvertently block affiliate tags, preventing users from earning rewards. The integrated system overcomes this limitation by providing a dynamic rewards selector that intelligently manages affiliate tags. Additionally, the use of advanced algorithms for ad detection and placeholder animation enhances user experience and system performance, making it a superior solution to existing ad-blockers and rewards programs.

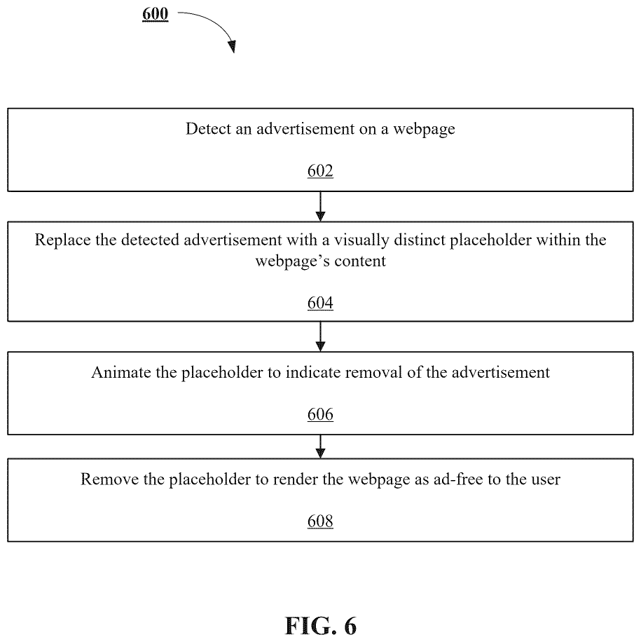

FIG. 6 is a flowchart of an example process 600 in accordance with the systems and methods described herein. In some implementations, one or more process blocks of FIG. 6 may be performed by a device.

As illustrated in FIG. 6, process 600 may include detecting an advertisement on a webpage (block 602). For example, a device implementing the method may detect an advertisement on a webpage, as described above. As illustrated in FIG. 6, process 600 may include replacing the detected advertisement with a visually distinct placeholder within the webpage's content (block 604). For example, the device may replace the detected advertisement with a visually distinct placeholder within the webpage's content, as described above. As further illustrated in FIG. 6, process 600 may include animating the placeholder to indicate the removal of the advertisement (block 606). For example, the device may animate the placeholder to indicate the removal of the advertisement, as described above. As illustrated in FIG. 6, process 600 may include removing the placeholder to render the webpage ad-free to the user (block 608). For example, the device may remove the placeholder to render the webpage ad-free to the user, as described above.

Although FIG. 6 illustrates example blocks of process 600, in some implementations, process 600 may include additional blocks, fewer blocks, different blocks, or blocks that are differently arranged than those depicted in FIG. 6. In some example embodiments, two or more of the blocks of process 600 may be performed in parallel.

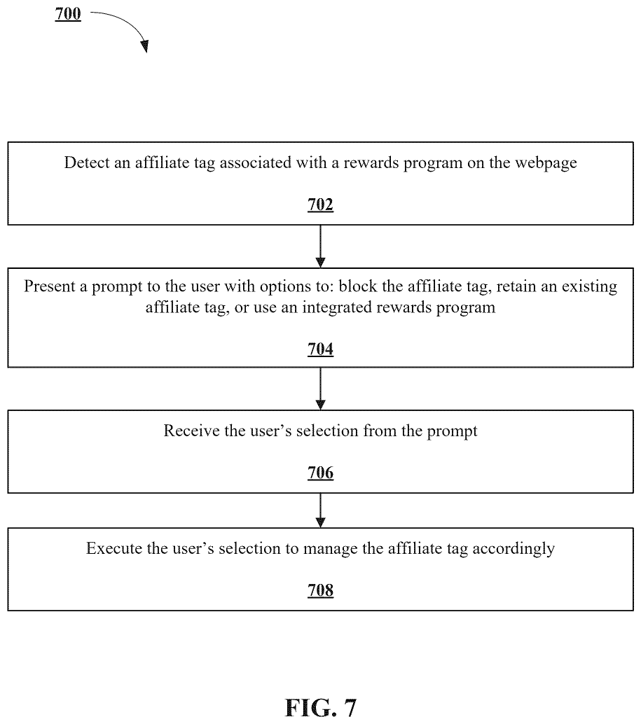

FIG. 7 is a flowchart of an example process 700 in accordance with the systems and methods described herein. In some implementations, one or more process blocks of FIG. 7 may be performed by a device implementing method 700. As illustrated in FIG. 7, process 700 may include detecting an affiliate tag associated with a rewards program on the webpage (block 702). For example, a device implementing the method may detect an affiliate tag associated with a rewards program on the webpage, as described above. As illustrated in FIG. 7, process 700 may include presenting a prompt to the user with options to block the affiliate tag, retain an existing affiliate tag, or use an integrated rewards program (block 704). For example, the device implementing the method may present a prompt to the user with options to block the affiliate tag, retain an existing affiliate tag, or use an integrated rewards program, as described above. As further illustrated in FIG. 7, process 700 may include receiving the user's selection from the prompt (block 706). For example, the device implementing the method may receive the user's selection from the prompt, as described above. As illustrated in FIG. 7, process 700 may include executing the user's selection to manage the affiliate tag accordingly (block 708). For example, the device implementing the method may execute the user's selection to manage the affiliate tag accordingly, as described above.

Although FIG. 7 illustrates example blocks of process 700; in some implementations, process 700 may include additional blocks, fewer blocks, different blocks, or differently arranged blocks than those depicted in FIG. 7. In some embodiments, two or more of the blocks of process 700 may be performed in parallel.

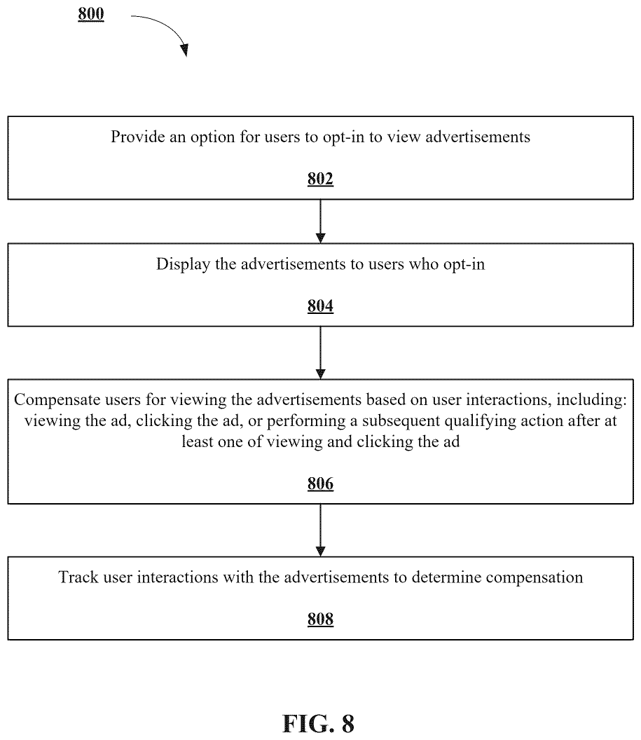

FIG. 8 is a flowchart of an example process 800 in accordance with the systems and methods described herein. In some implementations, one or more process blocks of FIG. 8 may be performed by a device implementing method 800.

As illustrated in FIG. 8, process 800 may include allowing users to opt-in to view advertisements (block 802). For example, a device implementing the method may provide an option for users to opt-in to view advertisements, as described above. As illustrated in FIG. 8, process 800 may include displaying the advertisements to users who opt-in (block 804). For example, the device implementing the method may display the advertisements to users who opt-in, as described above. As further illustrated in FIG. 8, process 800 may include compensating users for viewing the advertisements based on user interactions, including viewing the ad, clicking the ad, or performing a subsequent qualifying action after at least one of viewing and clicking the ad (block 806). For example, the device implementing the method may compensate users for viewing the advertisements based on user interactions, including viewing the ad, clicking the ad, or performing a subsequent qualifying action after at least one of viewing and clicking the ad, as described above. As illustrated in FIG. 8, process 800 may include tracking user interactions with the advertisements to determine compensation (block 808). For example, the device implementing the method may track user interactions with the advertisements to determine compensation, as described above.

Although FIG. 8 illustrates example blocks of process 800, in some implementations, process 800 may include additional blocks, fewer blocks, different blocks, or blocks that are differently arranged than those depicted in FIG. 8. In some embodiments, two or more of the blocks of process 800 may be performed in parallel.

Methods of FIGS. 6-8 and their Separate and Combined Functionality

The described methods in FIGS. 6-8 illustrate distinct processes that can operate independently or be combined to enhance user experiences with ad-blocking and rewards programs. Each figure represents a different core functionality: Visual Mode (FIG. 6), Rewards Selector (FIG. 7), and Rewards for Ads (FIG. 8). These methods can be implemented separately, providing individual benefits, or integrated into a comprehensive system, offering a seamless user experience. (Each possible combination of two or three of these methods, as well as the individual methods, is possible.)

As discussed above, FIG. 6 depicts a method for visually enhancing the user experience with ad-blocking. FIG. 7 illustrates a method for managing affiliate tags associated with rewards programs. FIG. 8 describes a method for compensating users for viewing advertisements.

### Integration of Methods

The methods described in FIGS. 6-8 can function independently, each providing a specific enhancement to the user experience. However, they can also be combined to create a comprehensive system. For example, the Visual Mode (FIG. 6) may operate alongside the Rewards Selector (FIG. 7) to provide ad-blocking and dynamic rewards management within the same browser environment. The Rewards for Ads method (FIG. 8) may be integrated with either or both methods, allowing users to choose between ad-free browsing or opting in to view ads for compensation while managing affiliate tags dynamically. In other example embodiments, the Visual Mode (FIG. 6), the Rewards Selector (FIG. 7), and the Rewards for Ads method (FIG. 8) may all be combined. By structuring the system to allow each method to function separately or in combination, users may benefit from a tailored browsing experience that meets their preferences for ad-blocking, rewards management, and ad viewing compensation.

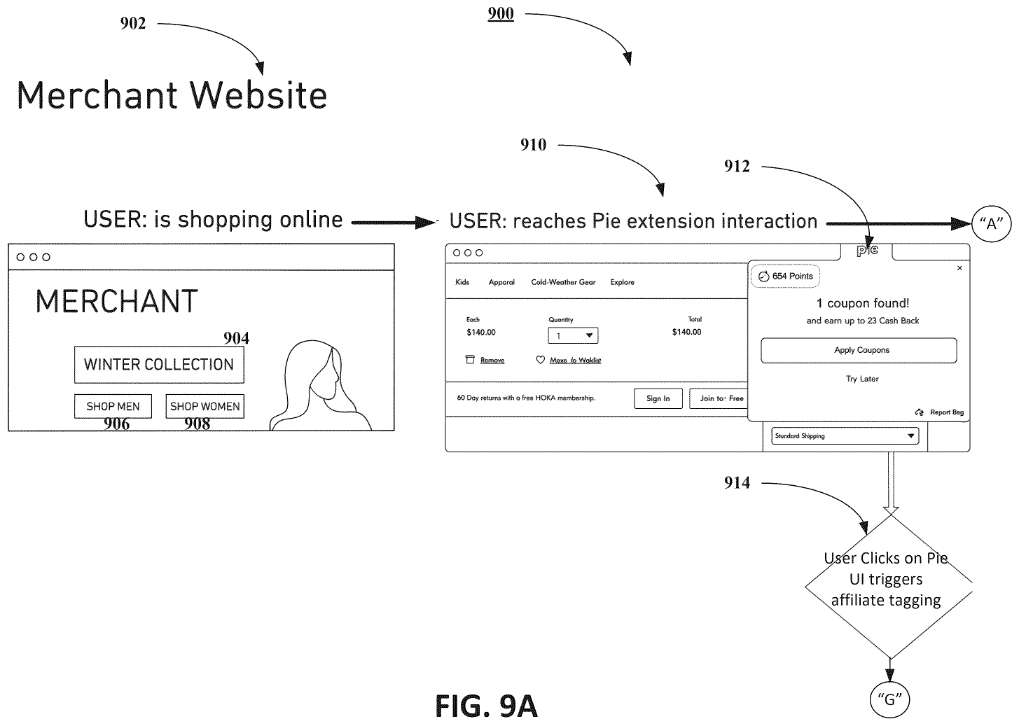

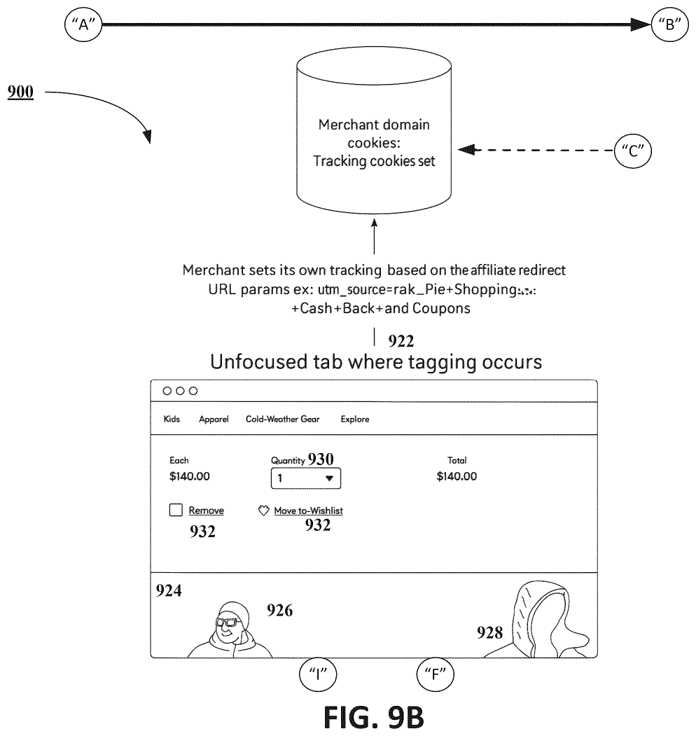

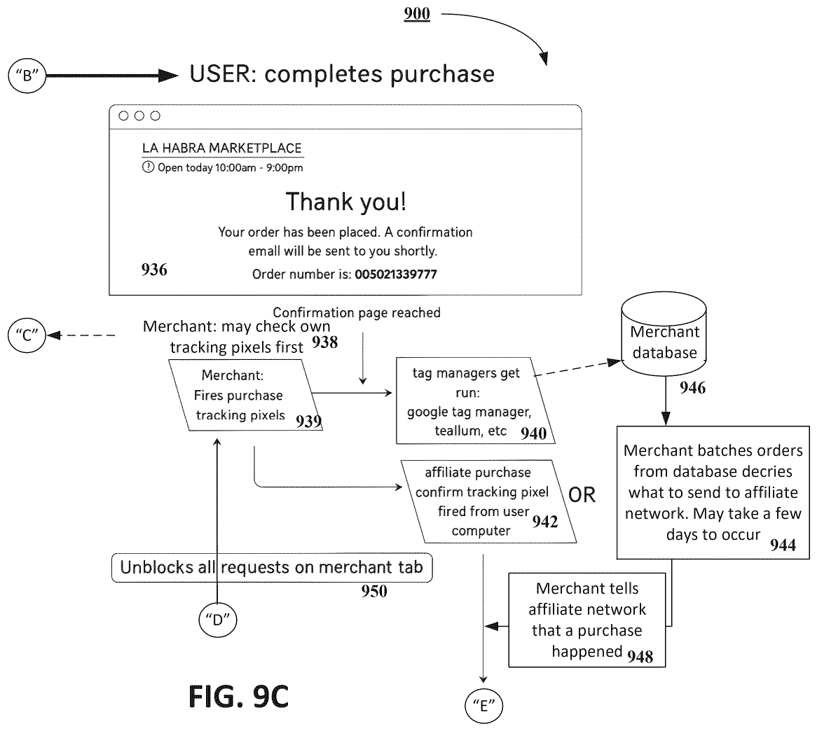

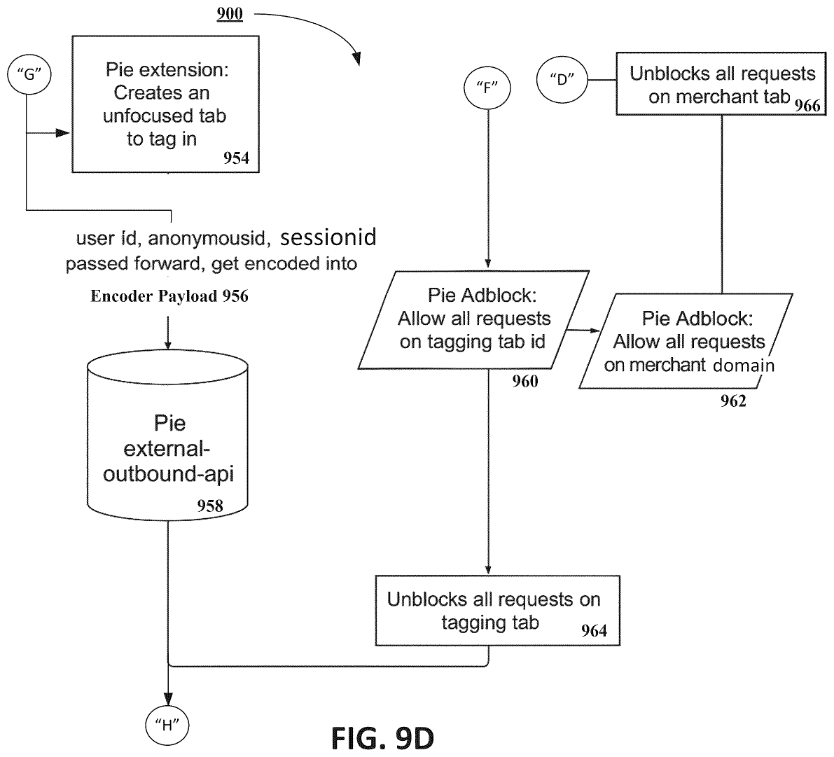

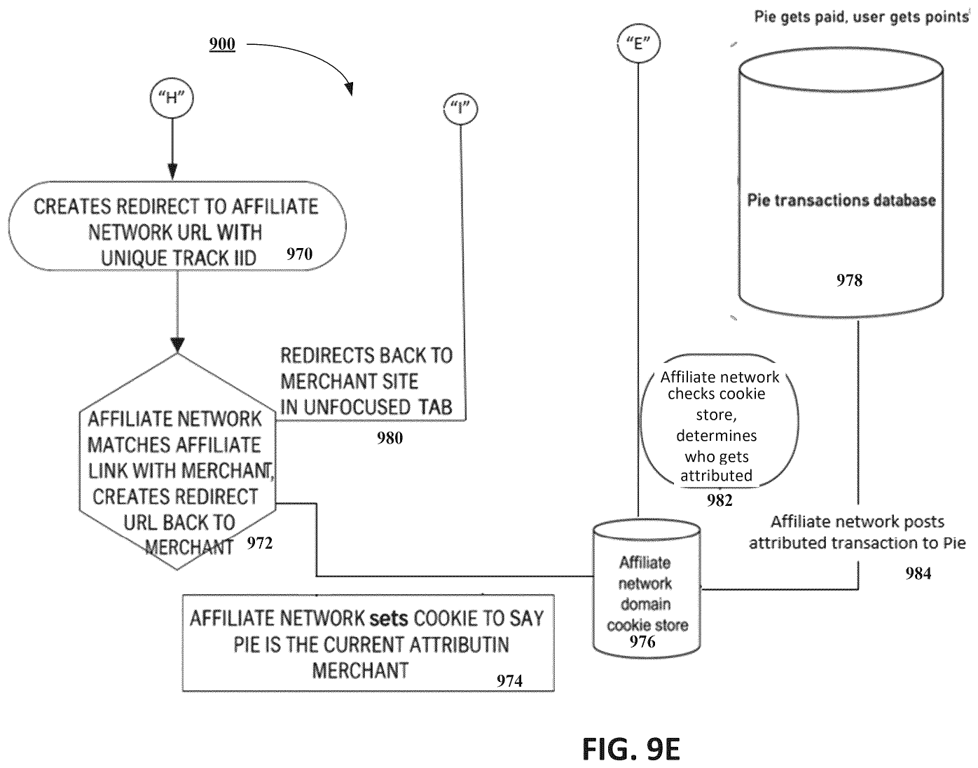

FIGS. 9A-9E illustrate a high-level flowchart 900 of the data experience within the integrated ad-blocker and dynamic rewards selector system. This diagram provides an overview of an example of how user interactions with the system translate into backend processes and outcomes. Initially, the system may detect webpage elements, including advertisements and affiliate tags, through a parsing operation performed by the browser extension on the user device. Once detected, the system may process the elements based on predefined rules stored locally or accessed via a backend server. Lettered nodes such as “A,” “B,” “C,” etc., are used across FIGS. 9A-9E to indicate flow continuity between sequential stages of the process.

FIG. 9A illustrates a user interface 900 displayed on a merchant website 902 in which a user may browse products such as a winter collection 904. Interface 900 includes selectable product categories such as “Shop Men” 906 and “Shop Women” 908. The merchant website 902 may be rendered within a browser window 910 that includes a Pie extension interface trigger 912 positioned near the browser toolbar area. The user may click 914 on the Pie extension interface trigger 912. The user interface 900 serves as the entry point for product exploration and initiates the extension's monitoring of relevant browsing activity.

FIG. 9B illustrates an example tagging flow in which tracking cookies are set by a merchant domain in response to an affiliate redirect, including scenarios where tagging occurs in an unfocused browser tab. The process begins when a user is redirected via an affiliate link to a merchant domain, where the merchant's tracking infrastructure is engaged.

At the merchant domain, a server receives the redirected request and sets one or more tracking cookies 922 associated with the merchant's domain. These cookies may store information about referral source, affiliate ID, campaign identifiers, or promotional attributes (e.g., cashback eligibility, coupon triggers).

In one embodiment, the server may parse URL parameters such as utm_source, utm_campaign, or custom values (e.g., source=rak_Pie_Shopping) embedded within the redirect URL to determine the context and type of affiliate attribution. Parsed values are used to initialize or update tracking cookies 922 stored in the user's browser for session or persistent tracking.

The illustrated interface 924 represents a browser tab loaded with a merchant shopping page, such as a checkout or product page. Notably, the interface 924 is unfocused during the tagging event, meaning it may be rendered in the background or in a hidden tab without active user interaction.

Within the interface 924, visual elements 926 and 928 represent example product images or user interface assets associated with the displayed cart. A quantity selector 930 allows product quantity adjustment, and an action button 932 permits user actions such as saving items to a wishlist or removing them from the cart. These controls may be non-interactive or hidden in the tagging context, as their primary purpose is to support cookie initialization by simulating a valid page load.

This background tagging flow enables the merchant domain to record referral-based attribution without requiring the user to complete a transaction or interact with the page. In some embodiments, this mechanism may be used to credit affiliate networks, trigger offer eligibility, or log impression-based tracking events compliant with advertising and analytics frameworks.

FIG. 9C illustrates a continuation of the tagging and conversion tracking flow, specifically depicting the series of events that occur after a user completes a purchase on a merchant website. As illustrated, the process begins when the user completes a transaction and reaches a confirmation page 936, which displays a thank-you message and an order number (e.g., “Order number is: 905003399777”) indicating successful checkout.

At this stage, the browser tab renders a merchant confirmation page 936, which may typically be considered the authoritative event marker for conversion. Upon reaching this page, the merchant may initiate one or more tracking events. In some embodiments, the merchant first executes internal validation processes (e.g., verifying session data, inventory, or payment status) prior to firing third-party pixels.

Once the merchant confirms the purchase event internally, it may activate one or more tracking pixels 938. These are typically JavaScript- or image-based beacons that send purchase data to designated analytics or advertising systems. The merchant may trigger these pixels directly from the confirmation page (client-side), or indirectly through server-side batch processing, as discussed further below. In some implementations, the merchant may first fire a first-party tracking pixel 939, which records the purchase event in the merchant's own analytics or logging system prior to executing any third-party tags.

Tag management systems 940, such as Google Tag Manager™ or Tealium™, may coordinate the activation of various pixels associated with internal analytics, marketing platforms, or affiliate tracking infrastructure. These tag managers execute predefined rules or scripts when the confirmation page is loaded.

In one implementation path, an affiliate purchase confirmation pixel 942 is fired from the user's browser at the time the confirmation page is rendered. This pixel typically contains encoded parameters that identify the purchase, such as order ID, total amount, and the affiliate source (retrieved from previously set cookies as described in FIG. 9B).

In an alternate implementation, the merchant may not immediately notify the affiliate network. Instead, the purchase is first logged in the merchant's internal order database 944, which stores structured records of completed transactions. These records include metadata such as timestamps, affiliate identifiers, order values, and channel information.

The merchant may batch process 944 the order data from the database 946 at periodic intervals (e.g., daily or weekly), applying business rules to determine which purchases qualify for affiliate credit. After this processing, the merchant then informs the affiliate network that a purchase has occurred, either by calling an API or firing a server-side pixel 946.

This final notification 948 informs the affiliate network that the purchase can be attributed to the original referral. In some configurations, this server-side event includes reconciliation data, fraud screening results, or deduplication logic, ensuring that affiliate commissions are only paid for qualified conversions.

As part of this post-conversion flow, the merchant system may also unblock previously deferred third-party requests 950 that were suppressed during the user's session to optimize performance or manage tag execution order. These deferred requests may now be processed to finalize downstream attribution, ad campaign measurement, or loyalty rewards.

FIG. 9D illustrates an extension of the tagging workflow, in which the Pie browser extension coordinates session tracking and request unblocking logic across multiple tabs. As shown, the Pie extension creates an unfocused browser tab to facilitate tagging operations in the background. This tab operates without requiring user interaction or visible rendering, allowing tracking logic to be executed asynchronously. The Pie extension 954 initializes this tab creation in response to an affiliate-triggered event or a system-determined tagging opportunity.

As part of the initialization, the extension collects session-level metadata, such as a user ID, anonymous identifier, or browser session token. These values are encoded into a structured request and forwarded to a remote orchestration service, referred to in FIG. 9D as the Pie external-outbound API 958. The encoded payload 956 allows the server to correlate tagging activity across different tabs and coordinate interactions with affiliate and merchant domains.

The outbound API may respond with tagging directives or updated policies, including instructions to temporarily relax network restrictions on specific domains or browser contexts. In response, the Pie Adblock system activates one or more request-permission modules. In one path, the Adblock logic allows all requests originating from the tagging tab itself, as indicated by reference character 960. In another path, the Adblock logic permits requests directed to the merchant domain, as shown at 962. These dynamic unblocking rules ensure that otherwise-suppressed resources-such as tracking pixels, embedded scripts, or tag manager routines can be executed successfully in both the tagging and merchant contexts.

Once the appropriate request filters are disabled, a rule enforcement layer 964 ensures that all outbound requests from the tagging tab are permitted for the duration of the session. Simultaneously, a parallel operation 966 may unblock previously suppressed requests on the merchant tab, thereby completing the setup for affiliate tracking or conversion attribution.

This mechanism enables selective override of blocking behavior in privacy-preserving environments, allowing necessary affiliate logic to complete without exposing the user to extraneous third-party tracking in non-tagging contexts.

FIG. 9E illustrates an affiliate redirection and attribution process that completes the tagging workflow initiated in earlier steps of the flowchart 900. The illustrated process includes background operations involving a browser extension, an affiliate network, and a backend transaction tracking system.

At block 970, the system creates a redirect to an affiliate network URL that includes a unique tracking identifier (IID). This redirect occurs automatically within an unfocused browser tab that was previously initialized for tracking purposes. The redirect does not interrupt the user's active browsing session and ensures that tracking occurs in the background.

At decision block 972, the affiliate network receives the redirect request and attempts to match the incoming affiliate link with a known merchant. If the affiliate network successfully associates the IID with a known merchant, it generates a secondary redirect URL that points to the merchant's website. This secondary redirect URL is followed automatically by the system, thereby returning the unfocused tagging tab to the merchant site context. The redirect action that returns the browser to the merchant's website in the unfocused tab is represented by reference character 980, and occurs automatically following successful link resolution at the affiliate network.

As part of this return path, the affiliate network sets a browser cookie in the affiliate network's domain. As shown at block 974, this cookie stores information indicating that the system operating in the current session is the party entitled to affiliate attribution. Specifically, the cookie reflects that the browser extension or system initiating the redirect is the current attributing merchant for the purposes of downstream purchase recognition.

The affiliate network later uses this cookie information, stored in its domain cookie store 976, to determine which party should receive attribution when a transaction occurs. As shown in the adjacent process bubble, the affiliate network checks its cookie store to identify which system or extension should be credited for the transaction. This attribution logic is further illustrated at process bubble 982, where the affiliate network applies its cookie-based rules to determine the proper attribution party based on the contents of the cookie store.

Once a qualifying transaction is detected, the affiliate network posts the attributed transaction, as represented at reference character 984, to the backend system associated with the extension. The transaction data is stored in a central transaction database 978, which logs the event and associates it with the original IID. As a result of this successful attribution, the backend system may award points, rewards, or incentives to the user, and the operator of the extension or system may receive payment for the successful referral.

In an example embodiment, the data flow may begin at the user's device (e.g., a laptop or mobile device) when a webpage, e.g., a merchant website, may be loaded. As the webpage's content may be parsed, the system may identify advertisement elements and replaces them with visually distinct placeholders. These placeholders may be animated and eventually removed to render the webpage as ad-free. Simultaneously, the system may scan for affiliate tags associated with rewards programs and notifies the user through a prompt. User responses, such as blocking or allowing affiliate tags, may be logged and processed locally on the user device or transmitted securely to the backend server for further handling.

In an example embodiment, on the backend, the system may leverage a conventional topology, including a web server coupled to a database server. The web server may process user inputs, while the database server stores rules for ad-blocking and rewards management, user preferences, and usage analytics. This modular backend architecture may allow real-time updates to ad-blocking algorithms and seamless synchronization of user settings across devices.

In an example embodiment, the integrated ad-blocker and dynamic rewards selector system also incorporates a feature called “Money Mode,” which may enhance user engagement by combining referral-based rewards with ad-blocking functionality. This feature may operate through two states: the “opportunity state” and the “earned state.”

In an example embodiment, in the opportunity state, users may be invited to participate in Money Mode by referring others to the service. Upon a successful referral and sign-up by the referred user, Money Mode may activate, allowing the referring user to earn contingent rewards. These contingent rewards may be linked to the referring user's account and appear in the Rewards Hub interface, providing clear visibility of the progress toward earning them.

In an example embodiment, the earned state may be initiated as the referring user continues interacting with the service. For each advertisement blocked, the system may provide immediate visual feedback through animated placeholders and contextual messaging, such as, “Ad removed!You've earned X points,” (where “X” may be replaced by some number of points). This feedback may reassure the user of the system's functionality while reinforcing the value of their interaction. The accumulated points may transition from contingent to earned status upon reaching the predetermined threshold, with notifications sent to the user to celebrate their achievement.

In an example embodiment, Money Mode may rely on robust backend architecture, including a Reward Calculation Engine that logs and processes user interactions. This engine may be responsible for tracking the contingent rewards in the opportunity state and dynamically updating the user's status as they progress to the earned state. By combining user-friendly interfaces and seamless backend processing, Money Mode may provide an engaging experience that incentivizes continued interaction with the system.

In an example embodiment, the backend system may securely manage user data, including ad-blocking rules, affiliate tag metadata, and user interaction logs. User preferences may be stored using encrypted databases to ensure confidentiality, and session rules are designed to be ephemeral, created on-demand and automatically cleared after a specified period. To prevent data leakage between browser sessions or tabs, the backend system may employ unique session identifiers and cross-origin isolation techniques. These mechanisms ensure robust security and data integrity across all user interactions.

In an example embodiment, the backend system may manage session rules securely by leveraging a time-bound ephemeral storage mechanism. These session rules may be encrypted using industry-standard algorithms (e.g., AES-256) and are accessible only through unique session identifiers. By maintaining separate namespaces for each browser session, the system may help ensure that temporary rules created for one session cannot inadvertently affect others. Rules may be programmatically removed either upon expiration or when the associated transaction completes, providing robust isolation and privacy.

In an example embodiment, communication between the ad-blocker extension and rewards management system may be facilitated through JSON-encoded messages sent over a secure browser-defined channel. Each message may include metadata specifying the action to be performed (e.g., create rule, remove rule), a target identifier (e.g., tabId or domain), and an expiration timestamp. The ad-blocker extension may validate incoming messages using a cryptographic signature to prevent tampering or unauthorized actions. These protocols may help ensure seamless integration while maintaining high standards of security and reliability.

In an example embodiment, edge case scenarios may be accounted for within the system's design. For example, if a user closes the browser tab before completing a transaction, the associated temporary rules may be immediately purged to prevent unintended access. Similarly, if the affiliate domain changes unexpectedly during the transaction, the system may retry the tagging process with updated parameters retrieved from a real-time rule repository maintained in the backend.

In an example embodiment, temporary rule creation may offer advantages over preconfigured or static rules. By dynamically generating rules at runtime, the system may minimize its attack surface and reduces resource consumption. This approach may help ensure that ad-blocking remains unaffected for tabs or domains not explicitly involved in the transaction, thereby preserving the core functionality of ad-blocking while enabling rewards tracking.

In an example embodiment, consider a user browsing different e-commerce websites simultaneously across different tabs within a browser: example.com and anotherexample.com. If the user interacts with a cashback offer on example.com, the ad-blocker extension may create a temporary rule specific to the example.com tab while leaving the anotherexample.com tab unaffected. This selective application may help ensure that the user's browsing experience on other tabs remains private and uninterrupted.

In an example embodiment, the system may be designed to scale seamlessly to support millions of concurrent users by offloading complex rule management tasks to a distributed cloud infrastructure. By maintaining a cloud-based repository for ad-blocking patterns and affiliate metadata, the system may help ensure real-time synchronization across devices and updates to blocking rules without requiring user intervention.

In an example embodiment, in enterprise environments, the system may be adapted to enforce conditional access rules for employees. For instance, temporary permissions may be granted to access restricted internal resources based on the employee's current task or project, with rules automatically expiring after the task is completed.

### Backend System Architecture

In an example embodiment, the backend system may include a web server that interfaces with the browser extension running on user devices. The web server may manage requests related to ad-blocking rule updates and affiliate tag processing. For example, when an affiliate tag is allowed by the user, the backend may verify the tag's validity, ensuring compliance with privacy standards. The database server, e.g., integrated with the web server, may store metadata for advertisements and affiliate tags, user interaction history, and analytics for ad-blocking efficiency. This architecture may support scalability and cross-platform compatibility, enabling the system to handle high volumes of user interactions seamlessly.

### Frontend Hardware and User Interface Features

In an example embodiment, the system's frontend may be designed to run efficiently on a wide range of devices, including desktops, laptops, and mobile phones. The browser extension may integrate seamlessly with popular browsers and provides user-friendly interfaces. Features may include animated placeholders that visually indicate ad-blocking activity and dynamic prompts for managing affiliate tags. The interface design may prioritize accessibility, offering options such as remembering user preferences for future visits and providing a summary of blocked advertisements. Screenshots of example user interfaces, as depicted in FIGS. 4 and 5, showcase features that highlight the system's market value.

### Use Case: Enabling Affiliate Tagging Through Conditional Adblock Rules

In an example embodiment, a specific use case may demonstrate the system's ability to overcome traditional ad-blocker limitations by enabling conditional affiliate tagging. When a user interacts with a browser extension on an e-commerce website, the system may notify the ad-blocker that an affiliate request is pending. The ad-blocker may create two temporary rules: one to allow requests from the specific tab and another to permit network requests on the merchant's website. This conditional allowance may help ensure that affiliate tags can proceed without compromising the ad-blocking functionality. After the transaction, these rules may automatically be cleared, maintaining user privacy and system efficiency.

Alternative approaches to enabling affiliate tagging through adblock rules may include:

Preconfigured Rules: In an example embodiment, using a static list of allowed affiliate domains pre-installed within the ad-blocker, which may bypass dynamic rule creation but lacks flexibility for real-time updates.

Proxy-Based Solutions: In an example embodiment, routing affiliate tag requests through a secure proxy server that may filter and validate the requests before forwarding them to the network, eliminating the need for local rule creation.

Tag Encryption: In an example embodiment, encrypting affiliate tags so they are not recognized as tracking elements by ad-blockers, though this approach could introduce complexities in decryption and validation. These alternative methods highlight the unique advantages of the proposed system, which dynamically creates and removes rules based on user interactions, offering a balance between functionality and user privacy.

The conditional rule creation system may be applied in other contexts beyond affiliate tagging. For example:
Enterprise Security: In an example embodiment, temporarily allowing or blocking specific network requests for employees accessing corporate intranet resources.
Parental Controls: In an example embodiment, dynamically enabling content filtering rules for children's devices based on pre-set schedules or detected activities.
E-Commerce Analytics: In an example embodiment, facilitating real-time data collection for A/B testing while respecting user privacy by dynamically enabling specific trackers during defined sessions. These alternative applications demonstrate the versatility of the invention in adapting to various domains requiring conditional rule enforcement.

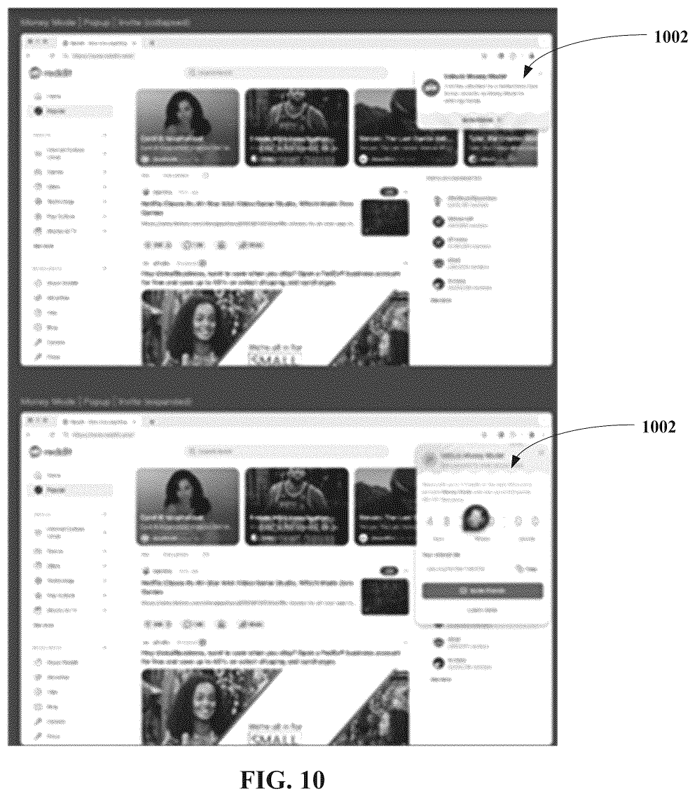

### Money Mode Overview (FIGS. 10-15)

In an example embodiment, the integrated ad-blocker and dynamic rewards selector system introduces an innovative feature called “Money Mode,” may be designed to enhance user engagement and reward users for their interactions. Money Mode may combine elements of referral programs with ad-blocking functionality to offer a unique contingent rewards system. This feature may operate in two phases: the “opportunity state” and the “earned state.”

In an example embodiment, the opportunity state, users may be invited to participate in Money Mode by referring other users to the service. When a referred user signs up, Money Mode activates, allowing the referring user to earn a predetermined number of points contingent upon continued interaction with the service.

FIG. 10 illustrates an example user interface screen showing an invitation 1002 for a user to participate in Money Mode by referring additional users, in accordance with the systems and methods described herein.

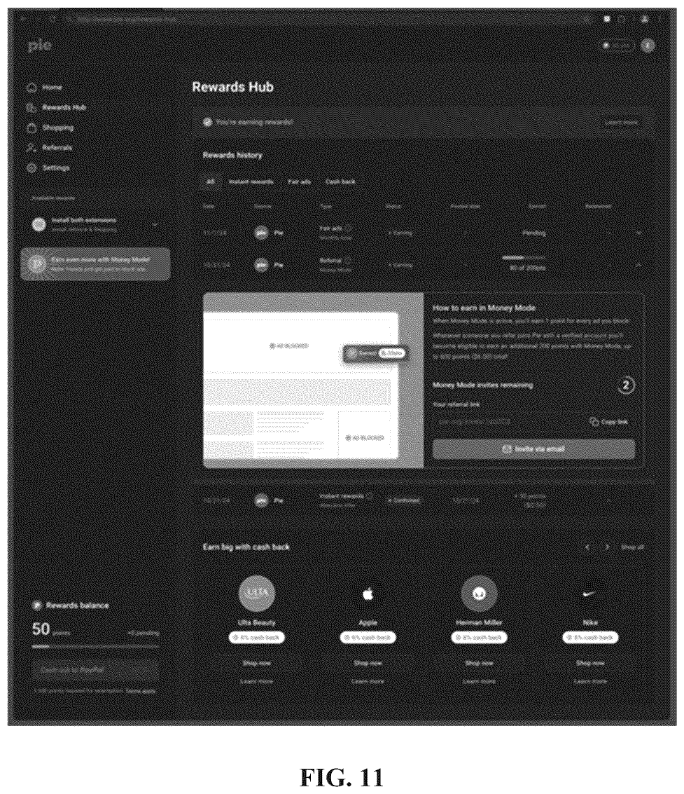

FIG. 11 illustrates an example Rewards Hub interface where the user can view detailed information about the opportunity to earn points in Money Mode, in accordance with the systems and methods described herein. In an example embodiment, one component of Money Mode may act as a Rewards Hub, where users can track their progress and learn more about the rewards available. Throughout the user's interaction, the system may keep the user informed about their progress in Money Mode.

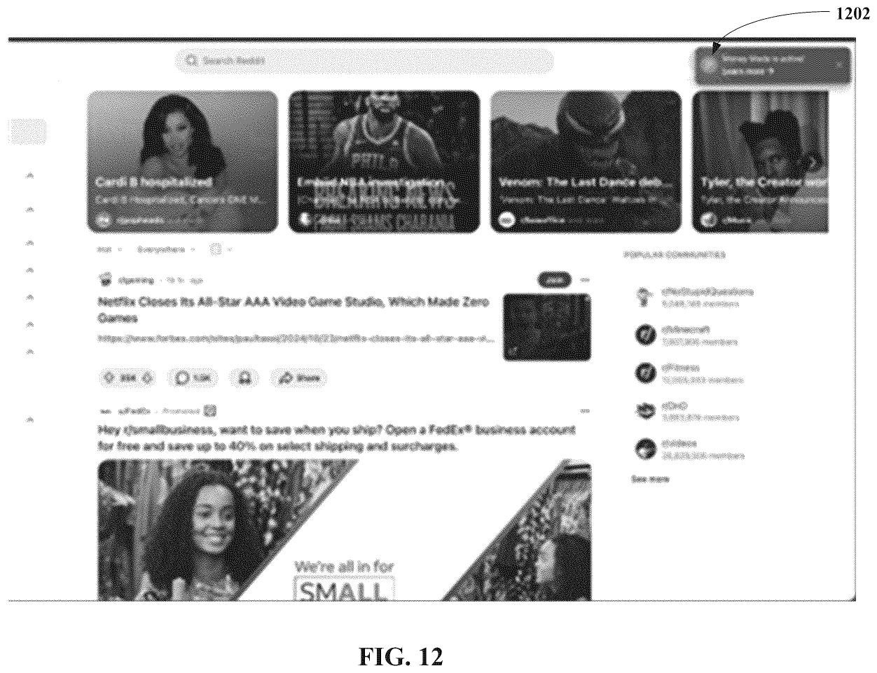

FIG. 12 illustrates an example asset displaying the user's current status in Money Mode 1202, including progress towards earning rewards, in accordance with the systems and methods described herein.

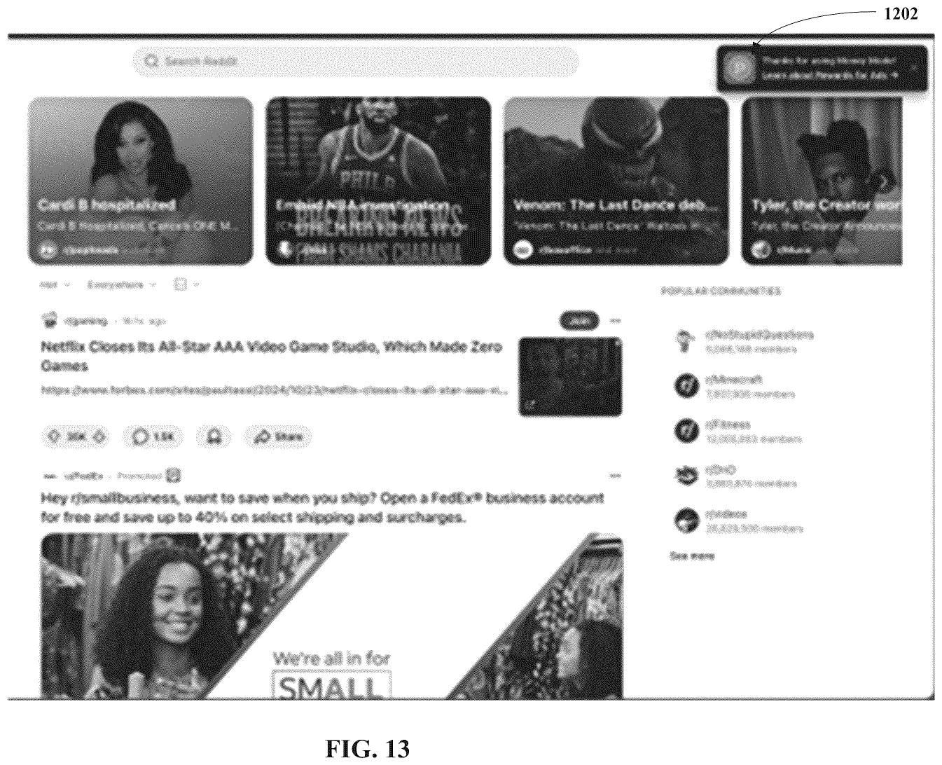

FIG. 13 illustrates another example asset informing the user of their progress in clearing contingent rewards while in Money Mode 1202, in accordance with the systems and methods described herein. Again, the screen displays the user's current status in Money Mode 1202.

In an example embodiment, once Money Mode is active, the referring user transitions into the earned state by interacting with the ad-blocking functionality. For each ad blocked by the system, a visually distinct animation may play, reinforcing the user's action and displaying a message indicating the number of points earned.

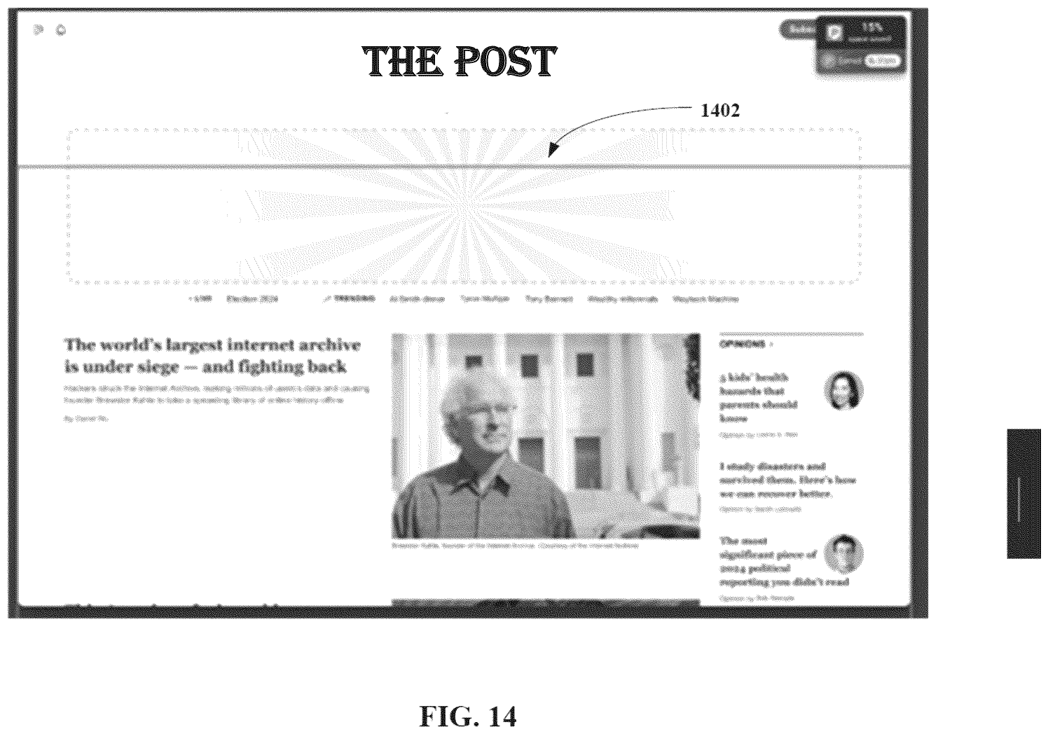

FIG. 14 illustrates an example user interface screen showing Money Mode operating to remove advertisements, e.g., at location 1402.

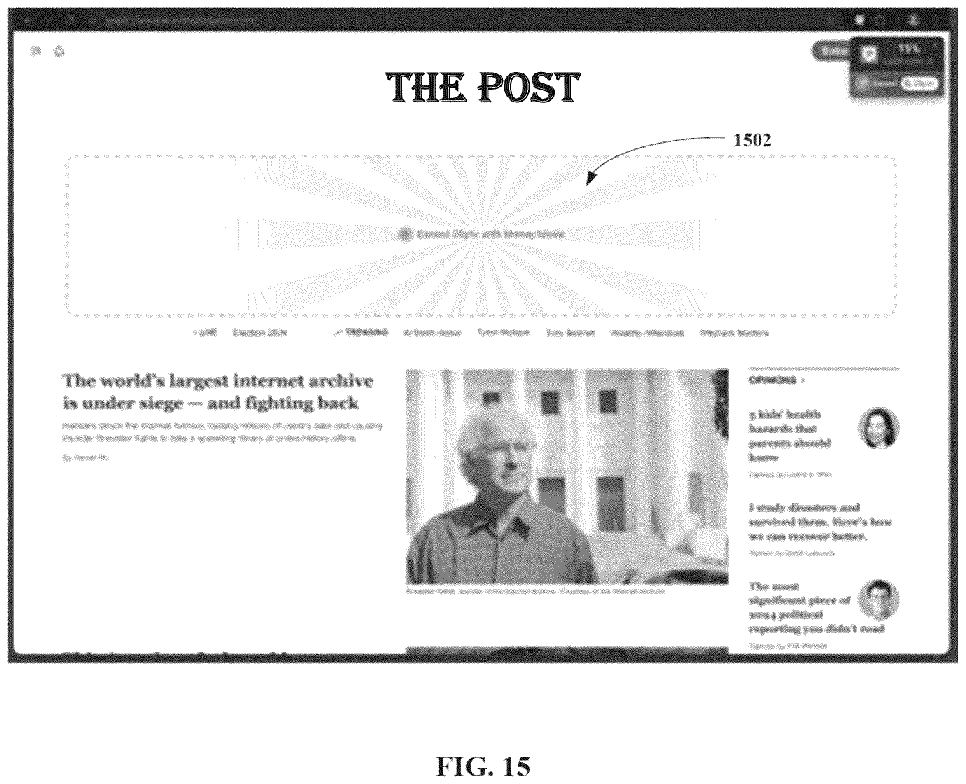

FIG. 15 illustrates another example user interface screen reinforcing the user's engagement with Money Mode by displaying a message 1502 about the number of points earned for the action, in accordance with the systems and methods described herein Some examples may display cumulative rewards earned through ad-blocking interactions.

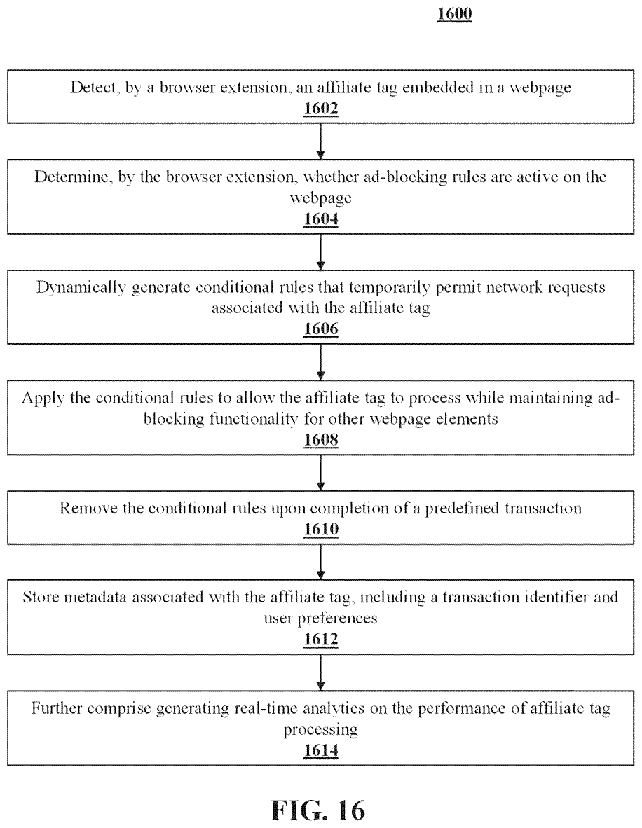

FIG. 16 is a flowchart of an example process 1600 in accordance with the systems and methods described herein. In some implementations, one or more process blocks of FIG. 16 may be performed by a device.

As illustrated in FIG. 16, process 1600 may include detecting, by a browser extension, an affiliate tag embedded in a webpage (block 1602). For example, a device may detect, by a browser extension, an affiliate tag embedded in a webpage, as described above. As also shown in FIG. 16, process 1600 may include determining, by the browser extension, whether ad-blocking rules are active on the webpage (block 1604). For example, device may determine, by the browser extension, whether ad-blocking rules are active on the webpage, as described above. As further shown in FIG. 16, process 1600 may include dynamically generating conditional rules that temporarily permit network requests associated with the affiliate tag (block 1606). For example, a device may dynamically generate conditional rules that temporarily permit network requests associated with the affiliate tag, as described above. As also shown in FIG. 16, process 1600 may include applying the conditional rules to allow the affiliate tag to process while maintaining ad-blocking functionality for other webpage elements (block 1608). For example, a device may apply the conditional rules to allow the affiliate tag to process while maintaining ad-blocking functionality for other webpage elements, as described above. As further shown in FIG. 16, process 1600 may include removing the conditional rules upon completion of a predefined transaction (block 1610). For example, a device may remove the conditional rules upon completion of a predefined transaction, as described above. As also shown in FIG. 16, process 1600 may include storing metadata associated with the affiliate tag, including a transaction identifier and user preferences (block 1612). For example, a device may store metadata associated with the affiliate tag, including a transaction identifier and user preferences, as described above.

As also shown in FIG. 16, process 1600 may include generating real-time analytics on the performance of affiliate tag processing (block 1614). For example, a device may generate real-time analytics on the performance of affiliate tag processing and store associated metadata, including a transaction identifier and user preferences, as described above.

Process 1600 may include additional implementations, such as any single implementation or any combination of implementations described below and/or in connection with one or more other processes described elsewhere herein. In a first implementation, the metadata is stored in a secure database and includes a timestamp of the affiliate tag's activation.

Although FIG. 16 shows example blocks of process 1600, in some implementations, process 1600 may include additional blocks, fewer blocks, different blocks, or differently arranged blocks than those depicted in FIG. 16. Additionally, or alternatively, two or more of the blocks of process 1600 may be performed in parallel.

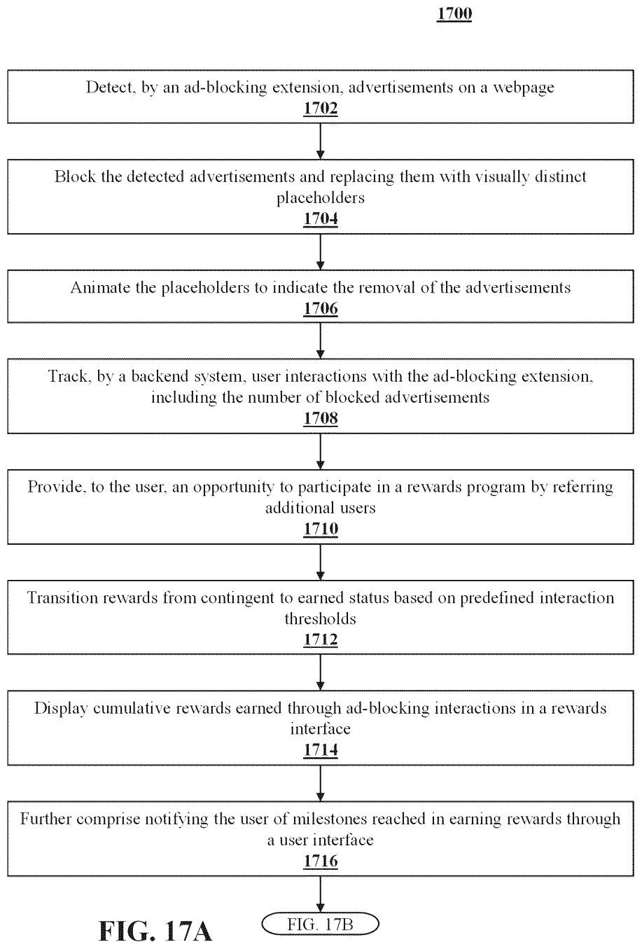

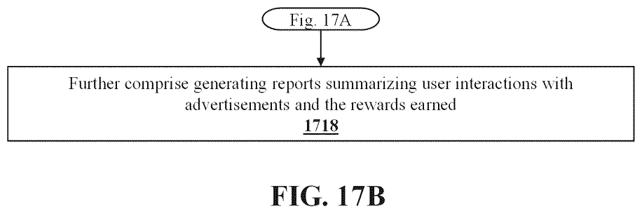

FIGS. 17A-B illustrate a flowchart of an example process 1700 in accordance with the systems and methods described herein. In some implementations, one or more process blocks of FIGS. 17A-B may be performed by a device.

As illustrated in FIG. 17A, process 1700 may include detecting, by an ad-blocking extension, advertisements on a webpage (block 1702). For example, device may detect, by an ad-blocking extension, advertisements on a webpage, as described above. As also shown in FIG. 17A, process 1700 may include blocking the detected advertisements and replacing them with visually distinct placeholders (block 1704). For example, device may block the detected advertisements and replacing them with visually distinct placeholders, as described above. As further shown in FIG. 17A, process 1700 may include animating the placeholders to indicate the removal of the advertisements (block 1706). For example, device may animate the placeholders to indicate the removal of the advertisements, as described above. As also shown in FIG. 17A, process 1700 may include tracking, by a backend system, user interactions with the ad-blocking extension, including the number of blocked advertisements (block 1708). For example, device may track, by a backend system, user interactions with the ad-blocking extension, including the number of blocked advertisements, as described above. As further shown in FIG. 17A, process 1700 may include providing, to the user, an opportunity to participate in a rewards program by referring additional users (block 1710). For example, device may provide, to the user, an opportunity to participate in a rewards program by referring additional users, as described above. As also shown in FIG. 17, process 1700 may include transitioning rewards from contingent to earned status based on predefined interaction thresholds (block 1712). For example, device may transition rewards from contingent to earned status based on predefined interaction thresholds, as described above. As further shown in FIG. 17A, process 1700 may include displaying cumulative rewards earned through ad-blocking interactions in a rewards interface (block 1714). For example, device may display cumulative rewards earned through ad-blocking interactions in a rewards interface, as described above.

As further shown in FIG. 17A, process 1700 may include notifying the user of milestones reached in earning reward through a user interface (block 1716). For example, the device may notify the user of milestones reached in earning rewards by displaying cumulative progress and reward information within a dedicated user interface, as described above. As further shown in FIG. 17B, process 1700 may include generating reports summarizing user interactions with advertisements and the rewards earned (block 1718). For example, the device may generate summary reports that detail user interactions with blocked advertisements, track reward-earning activities, and present cumulative progress in a user-accessible format, as described above.

Process 1700 may include additional implementations, such as any single implementation or any combination of implementations described below and/or in connection with one or more other processes described elsewhere herein. A first implementation, process 1700 may include notifying the user of milestones reached in earning rewards through an user interface.

A second implementation, alone or in combination with the first implementation, process 1700 may include generating reports summarizing user interactions with advertisements and the rewards earned.

Although FIGS. 17A-B shows example blocks of process 1700, in some implementations, process 1700 may include additional blocks, fewer blocks, different blocks, or differently arranged blocks than those depicted in FIGS. 17A-B. Additionally, or alternatively, two or more of the blocks of process 1700 may be performed in parallel.

Various embodiments solve the technological problem of ensuring seamless operation of affiliate tagging in ad-blocked environments, which traditionally involves blocked network requests, while also improving user engagement through integrated visual and dynamic feedback mechanisms.

Various embodiments include a mechanism where ad-blockers dynamically generate temporary rules to permit specific network requests associated with affiliate tags. This rule generation and enforcement occur in real time, ensuring efficient data flow while maintaining robust ad-blocking functionality.

Some embodiments may improve browser performance due to optimized rule management. Some embodiments may enhance user privacy through time-bound, encrypted rules. Some embodiments may provide for greater scalability and seamless cross-device synchronization using backend cloud services. Some embodiments may provide for one or more of these.

An example embodiment may include a method including dynamically generating temporary network rules, tracking ad-blocked interactions, and securely transitioning points from contingent to earned status via backend processing.

In an example embodiment, the systems and methods described herein provide a technical solution to the challenges posed by the conflicting functionalities of ad-blocking technologies and affiliate-based rewards programs. By dynamically generating conditional, time-bound rules within a browser extension, the invention allows precise control over network requests, enabling affiliate tags to function seamlessly in ad-blocked environments while preserving user privacy. The integration of real-time visual feedback, such as animated placeholders, enhances the user experience by providing immediate, actionable transparency into ad-blocking activities. Furthermore, the backend architecture ensures scalability, security, and performance optimization through encrypted storage, ephemeral session rules, and synchronized updates across devices. These innovations address technical limitations of conventional systems and deliver a unified, customizable solution for managing ad-blocking, affiliate tracking, and rewards programs in a manner that is both user-centric and technically robust. The embodiments described herein are exemplary and non-limiting, and the invention may be adapted to other contexts and applications while maintaining its core technical principles.

The attached Appendix forms part of this disclosure and is incorporated herein by reference.

The preceding disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it is understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like) and may be used interchangeably with “one or more.” The phrase “only one” or similar language is used where only one item is intended. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

One or more elements or aspects or steps, or any portion(s) thereof, from one or more of any of the systems and methods described herein, may be combined with one or more elements or aspects or steps, or any portion(s) thereof, from one or more of any of the other systems and methods described herein and combinations thereof, to form one or more additional implementations and/or claims of the present disclosure.

One or more components, steps, features, and/or functions illustrated in the figures may be rearranged and/or combined into a single component, block, feature, or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this Application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for enabling affiliate tracking in ad-blocked environments, the method comprising:
detecting, by a browser extension, an affiliate tag embedded in a webpage;
determining, by the browser extension, whether ad-blocking rules are active on the webpage;
dynamically generating conditional rules that temporarily permit network requests associated with the affiliate tag;
applying the conditional rules to allow the affiliate tag to process while maintaining ad-blocking functionality for other webpage elements;
removing the conditional rules upon completion of a predefined transaction; and
storing metadata associated with the affiliate tag.

2. The method of claim 1, wherein the affiliate tag includes URL parameters associated with a specific rewards program.

3. The method of claim 1, wherein the conditional rules are encrypted and time-bound to ensure user privacy and security.

4. The method of claim 1, further comprising generating real-time analytics on a performance of affiliate tag processing.

5. The method of claim 1, wherein the metadata is stored in a secure database and includes a timestamp of an affiliate tag's activation.

6. A method for enhancing user experience with ad-blocking in a web browser, the method comprising:
detecting, by an ad-blocking extension, at least one advertisement on a webpage;
blocking at least one detected advertisement and replacing such advertisement with a visually distinct placeholder; and
animating such placeholder to indicate a removal of the advertisement.

7. The method of claim 6, further comprising notifying the user through a user interface of milestones reached in earning rewards, the rewards including at least one of monetary incentives, discounts, or loyalty points.

8. The method of claim 6, further comprising removing a placeholder to render the webpage as ad-free to the user.

9. The method of claim 6, further comprising generating reports summarizing user interactions with advertisements and rewards earned.

10. The method of claim 6, further comprising displaying a notification indicating a number of advertisements blocked on the webpage.

11. The method of claim 6, wherein animating the placeholders comprises fading the placeholder into a background.

12. The method of claim 6, further comprising saving a user selection for future visits to a same webpage.

13. The method of claim 6, further comprising detecting and disabling other ad-blocking extensions via a single user action.

14. The method of claim 6, wherein the method is performed on a mobile device within a single mobile application that integrates ad-blocking functionality and rewards program management.

15. The method of claim 14, wherein the mobile application is a browser extension for a mobile browser.

16. The method of claim 14, wherein the mobile application is a standalone mobile browser with built-in ad-blocking and rewards management functionality.

17. The method of claim 6, further comprising:
tracking, by a backend system, user interactions with the ad-blocking extension;
providing, to the user, an opportunity to participate in a rewards program based on one or more qualifying actions;
transitioning rewards from a contingent status to an earned status based on predefined interaction thresholds; and
displaying, in a rewards interface, cumulative rewards earned through user interactions with the ad-blocking extension.

18. A method for managing affiliate tags associated with rewards programs in a web browser, the method comprising:
detecting an affiliate tag associated with a rewards program on a webpage;
presenting a prompt to a user with options to: block the affiliate tag, retain the tag, or use an integrated rewards program;
receiving the user's selection from the prompt; and
executing the user's selection to manage the affiliate tag accordingly.

19. A device for enhancing user experience with ad-blocking and rewards programs in a web browser comprising:
one or more processors configured to:
detect, by the one or more processors, an advertisement on a webpage;
replace, by the one or more processors, the detected advertisement with a visually distinct placeholder within a webpage's content;
animate, by the one or more processors, the placeholder to indicate removal of the advertisement; and
remove, by the one or more processors, the placeholder to render the webpage as ad-free to the user.

20. The device of claim 19, wherein the one or more processors are further configured to display, by the one or more processors, a notification indicating a number of advertisements blocked on the webpage.

21. The device of claim 19, wherein the animation comprises fading the placeholder into a background.

22. The device of claim 19, wherein the one or more processors are further configured to:
the step of save, by the one or more processors, the user's selection for future visits to the same webpage.

23. The device of claim 19, wherein an integrated rewards program provides the user with monetary incentives or discounts.

24. The device of claim 19, wherein the one or more processors are further configured to detect and disabling other ad-blocking extensions via a single user action.

25. The device of claim 19, wherein the one or more processors are further configured to:
provide, by the one or more processors, an option for users to opt-in to view advertisements;
display, by the one or more processors, advertisements to users who opt-in;
compensate, by the one or more processors, users for viewing the advertisements either directly via an ad-blocker tool or through partnerships with publishers; and
track, by the one or more processors, user interactions with the advertisements to determine compensation.

26. The device of claim 19, wherein compensation is provided in a form of monetary rewards, discounts, or other benefits.

27. A method for compensating users for viewing advertisements in a web browser, the method comprising:
providing an option for users to opt-in to view advertisements;
displaying the advertisements to users who opt-in;
compensating users for viewing the advertisements based on user interactions, including:
viewing the ad,
clicking the ad, or
performing a subsequent qualifying action after at least one of viewing and clicking the ad; and
tracking user interactions with the advertisements to determine compensation.

28. A non-transitory computer-readable medium storing a set of instructions for enhancing user experience with ad-blocking and rewards programs in a web browser, the set of instructions comprising:
one or more instructions that, when executed by one or more processors of a device, cause the device to:
detect an advertisement on a webpage;
replace the detected advertisement with a visually distinct placeholder within a webpage's content;
animate the placeholder to indicate removal of the advertisement;
remove the placeholder to render the webpage as ad-free to the user;
detect an affiliate tag associated with a rewards program on the webpage;
present a prompt to the user with options to:
block the affiliate tag
retain an existing affiliate tag, or
use an integrated rewards program;
receive the user's selection from the prompt; and
execute the user's selection to manage the affiliate tag accordingly.

29. A method for providing contingent rewards based on user interaction with an ad-blocking system, the method comprising:
detecting, by an ad-blocking extension, advertisements on a webpage;
blocking the detected advertisements;
tracking, by a backend system, user interactions with the ad-blocking extension, including a number of blocked advertisements;
providing, to the user, an opportunity to participate in a rewards program by referring additional users;
transitioning rewards from contingent to earned status based on predefined interaction thresholds; and
displaying cumulative rewards earned through ad-blocking interactions in a rewards interface.

30. The method of claim 29, wherein a visually distinct placeholders include information about a percentage of screen space reclaimed by blocking advertisements.

31. The method of claim 29, further comprising notifying the user of milestones reached in earning rewards through a user interface.

32. The method of claim 29, wherein the rewards program includes monetary incentives, discounts, or loyalty points.

33. The method of claim 29, further comprising generating reports summarizing user interactions with advertisements and the rewards earned.
